(19) United States
(12) Patent Application Publication
(10) Pub. No.: US 2022/0391073 A1
(43) Pub. Date: Dec. 8, 2022

(54) USER INTERFACES FOR MANAGING RECEIPT AND TRANSMISSION OF CONTENT

(71) Applicant: Apple Inc., Cupertino, CA (US)

(72) Inventors: Elizabeth C. CRANFILL, San Francisco, CA (US); Meredith A. ROSS, San Francisco, CA (US); Ruben Gaele Jan VAN DER DUSSEN, San Francisco, CA (US)

(21) Appl. No.: 17/833,523

(22) Filed: Jun. 6, 2022

Related U.S. Application Data
(60) Provisional application No. 63/294,601, filed on Dec. 29, 2021.
(60) Provisional application No. 63/197,471, filed on Jun. 6, 2021.

(51) Int. Cl. G06F 3/04842; G06F 3/04817; G06F 3/0488; G06F 9/451

(52) U.S. Cl. CPC G06F 3/04842; G06F 3/04817; G06F 3/0488; G06F 9/451

(57) ABSTRACT

The present disclosure generally relates to managing receipt and/or transmission of content.

### CROSS-REFERENCE TO RELATED APPLICATION

This application claims priority to U.S. Provisional Patent Application No. 63/197,471, entitled “USER INTERFACES FOR MANAGING RECEIPT AND TRANSMISSION OF CONTENT,” filed on Jun. 6, 2021, and U.S. Provisional Patent Application No. 63/294,601, entitled “USER INTERFACES FOR MANAGING RECEIPT AND TRANSMISSION OF CONTENT,” filed on Dec. 29, 2021 the contents of each of which is hereby incorporated by reference in its entirety.

### FIELD

The present disclosure relates generally to computer user interfaces, and more specifically to techniques for managing receipt and transmission of content.

### BACKGROUND

As electronic devices such as smartphones have become more widely used, it has become easier and more commonplace to transmit different types of content between electronic devices.

### BRIEF SUMMARY

Some techniques for managing receipt and transmission of content using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for managing receipt and transmission of content. Such methods and interfaces optionally complement or replace other methods for managing receipt and transmission of content. Such methods and interfaces reduce the cognitive burden on a user and produce a more efficient human-machine interface. For battery-operated computing devices, such methods and interfaces conserve power and increase the time between battery charges.

In accordance with some embodiments, a method is described. The method comprises: at a computer system that is in communication with a display generation component and one or more input devices: detecting, via the one or more input devices, one or more user inputs corresponding to selection of one or more media items; after detecting the one or more user inputs corresponding to selection of one or more media items, detecting, via the one or more input devices, one or more user inputs corresponding to a request to transmit the selected one or more media items; and in response to detecting the one or more user inputs corresponding to the request to transmit the selected one or more media items: in accordance with a determination that the one or more media items satisfy a set of sensitive content criteria, displaying, via the display generation component, a visual indication that the one or more media items satisfy the set of sensitive content criteria; and in accordance with a determination that the selected one or more media items do not satisfy the set of sensitive content criteria, transmitting the selected one or more media items to an external computer system.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: detecting, via the one or more input devices, one or more user inputs corresponding to selection of one or more media items; after detecting the one or more user inputs corresponding to selection of one or more media items, detecting, via the one or more input devices, one or more user inputs corresponding to a request to transmit the selected one or more media items; and in response to detecting the one or more user inputs corresponding to the request to transmit the selected one or more media items: in accordance with a determination that the one or more media items satisfy a set of sensitive content criteria, displaying, via the display generation component, a visual indication that the one or more media items satisfy the set of sensitive content criteria; and in accordance with a determination that the selected one or more media items do not satisfy the set of sensitive content criteria, transmitting the selected one or more media items to an external computer system.

In accordance with some embodiments, a transitory computer-readable storage medium is described. The transitory computer-readable storage medium stores one or more programs configured to be executed by one or more processors of a computer system that is in communication with a display generation component and one or more input devices, the one or more programs including instructions for: detecting, via the one or more input devices, one or more user inputs corresponding to selection of one or more media items; after detecting the one or more user inputs corresponding to selection of one or more media items, detecting, via the one or more input devices, one or more user inputs corresponding to a request to transmit the selected one or more media items; and in response to detecting the one or more user inputs corresponding to the request to transmit the selected one or more media items: in accordance with a determination that the one or more media items satisfy a set of sensitive content criteria, displaying, via the display generation component, a visual indication that the one or more media items satisfy the set of sensitive content criteria; and in accordance with a determination that the selected one or more media items do not satisfy the set of sensitive content criteria, transmitting the selected one or more media items to an external computer system.

In accordance with some embodiments, a computer system is described. The computer system is configured to communicate with a display generation component and one or more input devices, and comprises: one or more processors; and memory storing one or more programs configured to be executed by the one or more processors, the one or more programs including instructions for: detecting, via the one or more input devices, one or more user inputs corresponding to selection of one or more media items; after detecting the one or more user inputs corresponding to selection of one or more media items, detecting, via the one or more input devices, one or more user inputs corresponding to a request to transmit the selected one or more media items; and in response to detecting the one or more user inputs corresponding to the request to transmit the selected one or more media items: in accordance with a determination that the one or more media items satisfy a set of sensitive content criteria, displaying, via the display generation component, a visual indication that the one or more media items satisfy the set of sensitive content criteria; and in accordance with a determination that the selected one or more media items do not satisfy the set of sensitive content criteria, transmitting the selected one or more media items to an external computer system.

In accordance with some embodiments, a computer system is described. The computer system is configured to communicate with a display generation component and one or more input devices, and comprises: means for detecting, via the one or more input devices, one or more user inputs corresponding to selection of one or more media items; means for, after detecting the one or more user inputs corresponding to selection of one or more media items, detecting, via the one or more input devices, one or more user inputs corresponding to a request to transmit the selected one or more media items; and means for, in response to detecting the one or more user inputs corresponding to the request to transmit the selected one or more media items: in accordance with a determination that the one or more media items satisfy a set of sensitive content criteria, displaying, via the display generation component, a visual indication that the one or more media items satisfy the set of sensitive content criteria; and in accordance with a determination that the selected one or more media items do not satisfy the set of sensitive content criteria, transmitting the selected one or more media items to an external computer system.

In accordance with some embodiments, a computer program product is described. The computer program product comprises one or more programs configured to be executed by one or more processors of a computer system that is in communication with a display generation component and one or more input devices, the one or more programs including instructions for: detecting, via the one or more input devices, one or more user inputs corresponding to selection of one or more media items; after detecting the one or more user inputs corresponding to selection of one or more media items, detecting, via the one or more input devices, one or more user inputs corresponding to a request to transmit the selected one or more media items; and in response to detecting the one or more user inputs corresponding to the request to transmit the selected one or more media items: in accordance with a determination that the one or more media items satisfy a set of sensitive content criteria, displaying, via the display generation component, a visual indication that the one or more media items satisfy the set of sensitive content criteria; and in accordance with a determination that the selected one or more media items do not satisfy the set of sensitive content criteria, transmitting the selected one or more media items to an external computer system.

In accordance with some embodiments, a method is described. The method comprises: at a computer system that is in communication with a display generation component and one or more input devices: displaying, via the display generation component, a communication session user interface corresponding to a communication session involving the computer system and one or more external computer systems, including a first external computer system; receiving visual content information corresponding to visual content transmitted into the communication session by the first external computer system; and in response to receiving the visual content information corresponding to visual content transmitted into the communication session by the first external computer system: in accordance with a determination that the visual content satisfies a set of sensitive content criteria, displaying, via the display generation component, a visual indication that the received visual content has been identified as potentially containing sensitive content without displaying the visual content.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: displaying, via the display generation component, a communication session user interface corresponding to a communication session involving the computer system and one or more external computer systems, including a first external computer system; receiving visual content information corresponding to visual content transmitted into the communication session by the first external computer system; and in response to receiving the visual content information corresponding to visual content transmitted into the communication session by the first external computer system: in accordance with a determination that the visual content satisfies a set of sensitive content criteria, displaying, via the display generation component, a visual indication that the received visual content has been identified as potentially containing sensitive content without displaying the visual content.

In accordance with some embodiments, a transitory computer-readable storage medium is described. The transitory computer-readable storage medium stores one or more programs configured to be executed by one or more processors of a computer system that is in communication with a display generation component and one or more input devices, the one or more programs including instructions for: displaying, via the display generation component, a communication session user interface corresponding to a communication session involving the computer system and one or more external computer systems, including a first external computer system; receiving visual content information corresponding to visual content transmitted into the communication session by the first external computer system; and in response to receiving the visual content information corresponding to visual content transmitted into the communication session by the first external computer system: in accordance with a determination that the visual content satisfies a set of sensitive content criteria, displaying, via the display generation component, a visual indication that the received visual content has been identified as potentially containing sensitive content without displaying the visual content.

In accordance with some embodiments, a computer system is described. The computer system is configured to communicate with a display generation component and one or more input devices, and comprises: one or more processors; and memory storing one or more programs configured to be executed by the one or more processors, the one or more programs including instructions for: displaying, via the display generation component, a communication session user interface corresponding to a communication session involving the computer system and one or more external computer systems, including a first external computer system; receiving visual content information corresponding to visual content transmitted into the communication session by the first external computer system; and in response to receiving the visual content information corresponding to visual content transmitted into the communication session by the first external computer system: in accordance with a determination that the visual content satisfies a set of sensitive content criteria, displaying, via the display generation component, a visual indication that the received visual content has been identified as potentially containing sensitive content without displaying the visual content

In accordance with some embodiments, a computer system is described. The computer system is configured to communicate with a display generation component and one or more input devices, and comprises: means for displaying, via the display generation component, a communication session user interface corresponding to a communication session involving the computer system and one or more external computer systems, including a first external computer system; means for receiving visual content information corresponding to visual content transmitted into the communication session by the first external computer system; and means for, in response to receiving the visual content information corresponding to visual content transmitted into the communication session by the first external computer system: in accordance with a determination that the visual content satisfies a set of sensitive content criteria, displaying, via the display generation component, a visual indication that the received visual content has been identified as potentially containing sensitive content without displaying the visual content.

In accordance with some embodiments, a computer program product is described. The computer program product comprises one or more programs configured to be executed by one or more processors of a computer system that is in communication with a display generation component and one or more input devices, the one or more programs including instructions for: displaying, via the display generation component, a communication session user interface corresponding to a communication session involving the computer system and one or more external computer systems, including a first external computer system; receiving visual content information corresponding to visual content transmitted into the communication session by the first external computer system; and in response to receiving the visual content information corresponding to visual content transmitted into the communication session by the first external computer system: in accordance with a determination that the visual content satisfies a set of sensitive content criteria, displaying, via the display generation component, a visual indication that the received visual content has been identified as potentially containing sensitive content without displaying the visual content.

In accordance with some embodiments, a method is described. The method comprises: at a computer system that is in communication with a display generation component and one or more input devices: receiving content transmission information associated with a first external computer system, wherein: the content transmission information is associated with a visual content item received at and/or transmitted by the first external computer system, and the content transmission information is sent to the computer system in accordance with a determination that the visual content item received at and/or transmitted by the first external computer system satisfies a set of content criteria; detecting, via the one or more input devices, one or more user inputs corresponding to a request to display a representation of the content transmission information; and in response to detecting the one or more user inputs corresponding to the request to display the representation of the content transmission information: displaying, via the display generation component and based on the received content transmission information, a user interface that includes a representation of at least some of the content transmission information associated with the first external computer system.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: receiving content transmission information associated with a first external computer system, wherein: the content transmission information is associated with a visual content item received at and/or transmitted by the first external computer system, and the content transmission information is sent to the computer system in accordance with a determination that the visual content item received at and/or transmitted by the first external computer system satisfies a set of content criteria; detecting, via the one or more input devices, one or more user inputs corresponding to a request to display a representation of the content transmission information; and in response to detecting the one or more user inputs corresponding to the request to display the representation of the content transmission information: displaying, via the display generation component and based on the received content transmission information, a user interface that includes a representation of at least some of the content transmission information associated with the first external computer system.

In accordance with some embodiments, a transitory computer-readable storage medium is described. The transitory computer-readable storage medium stores one or more programs configured to be executed by one or more processors of a computer system that is in communication with a display generation component and one or more input devices, the one or more programs including instructions for: receiving content transmission information associated with a first external computer system, wherein: the content transmission information is associated with a visual content item received at and/or transmitted by the first external computer system, and the content transmission information is sent to the computer system in accordance with a determination that the visual content item received at and/or transmitted by the first external computer system satisfies a set of content criteria; detecting, via the one or more input devices, one or more user inputs corresponding to a request to display a representation of the content transmission information; and in response to detecting the one or more user inputs corresponding to the request to display the representation of the content transmission information: displaying, via the display generation component and based on the received content transmission information, a user interface that includes a representation of at least some of the content transmission information associated with the first external computer system.

In accordance with some embodiments, a computer system is described. The computer system is configured to communicate with a display generation component and one or more input devices, and comprises: one or more processors; and memory storing one or more programs configured to be executed by the one or more processors, the one or more programs including instructions for: receiving content transmission information associated with a first external computer system, wherein: the content transmission information is associated with a visual content item received at and/or transmitted by the first external computer system, and the content transmission information is sent to the computer system in accordance with a determination that the visual content item received at and/or transmitted by the first external computer system satisfies a set of content criteria; detecting, via the one or more input devices, one or more user inputs corresponding to a request to display a representation of the content transmission information; and in response to detecting the one or more user inputs corresponding to the request to display the representation of the content transmission information: displaying, via the display generation component and based on the received content transmission information, a user interface that includes a representation of at least some of the content transmission information associated with the first external computer system.

In accordance with some embodiments, a computer system is described. The computer system is configured to communicate with a display generation component and one or more input devices and comprises: means for receiving content transmission information associated with a first external computer system, wherein: the content transmission information is associated with a visual content item received at and/or transmitted by the first external computer system, and the content transmission information is sent to the computer system in accordance with a determination that the visual content item received at and/or transmitted by the first external computer system satisfies a set of content criteria; means for detecting, via the one or more input devices, one or more user inputs corresponding to a request to display a representation of the content transmission information; and means for, in response to detecting the one or more user inputs corresponding to the request to display the representation of the content transmission information: displaying, via the display generation component and based on the received content transmission information, a user interface that includes a representation of at least some of the content transmission information associated with the first external computer system.

In accordance with some embodiments, a computer program product is described. The computer program product comprises one or more programs configured to be executed by one or more processors of a computer system that is in communication with a display generation component and one or more input devices, the one or more programs including instructions for: receiving content transmission information associated with a first external computer system, wherein: the content transmission information is associated with a visual content item received at and/or transmitted by the first external computer system, and the content transmission information is sent to the computer system in accordance with a determination that the visual content item received at and/or transmitted by the first external computer system satisfies a set of content criteria; detecting, via the one or more input devices, one or more user inputs corresponding to a request to display a representation of the content transmission information; and in response to detecting the one or more user inputs corresponding to the request to display the representation of the content transmission information: displaying, via the display generation component and based on the received content transmission information, a user interface that includes a representation of at least some of the content transmission information associated with the first external computer system.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for managing receipt and transmission of content, thereby increasing the effectiveness, efficiency, and user satisfaction with such devices. Such methods and interfaces may complement or replace other methods for managing receipt and transmission of content.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6L illustrate exemplary user interfaces for managing transmission of content in accordance with some embodiments.

FIG. 7 illustrates a flow diagram depicting a method for managing transmission of content in accordance with some embodiments.

FIGS. 8A-8L illustrate exemplary user interfaces for managing receipt of content in accordance with some embodiments.

FIG. 9 illustrates a flow diagram depicting a method for managing receipt of content in accordance with some embodiments.

FIGS. 10A-10O illustrate exemplary user interfaces for managing receipt and transmission of content in accordance with some embodiments.

FIG. 11 illustrates a flow diagram depicting a method for managing receipt and transmission of content in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for managing receipt and transmission of content. For example, there is a need for techniques that protect users receiving and/or transmitting sensitive content. Such techniques can reduce the cognitive burden on a user who receives and/or transmits content, thereby enhancing productivity. Further, such techniques can reduce processor and battery power otherwise wasted on redundant user inputs.

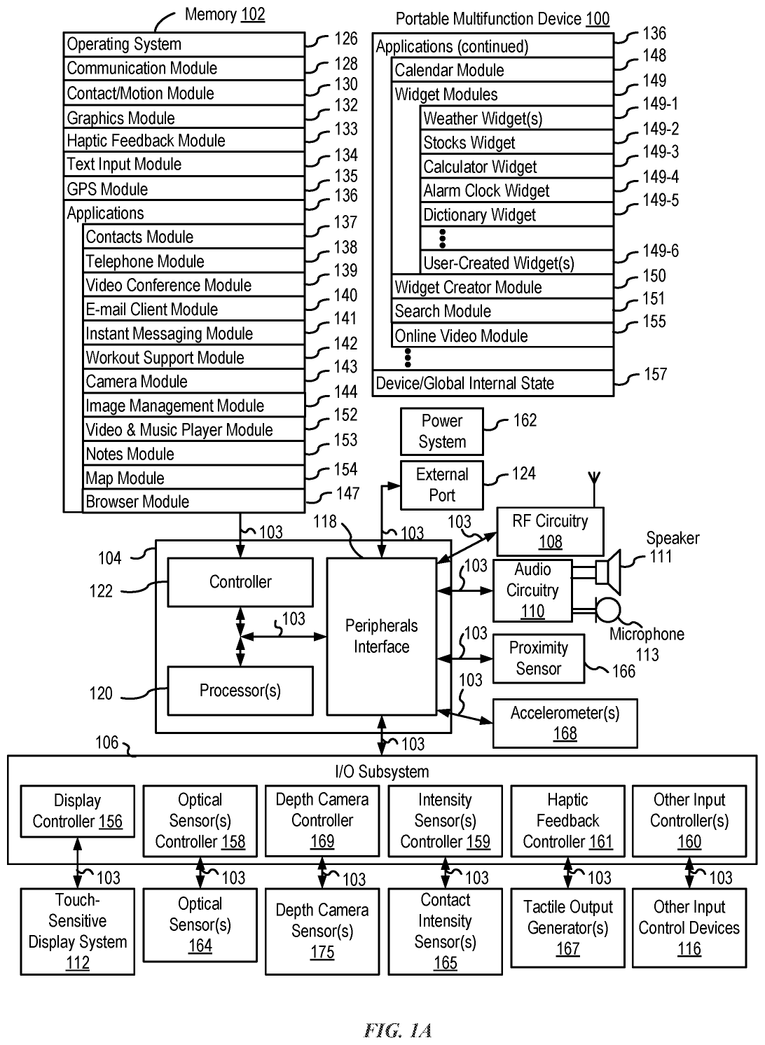

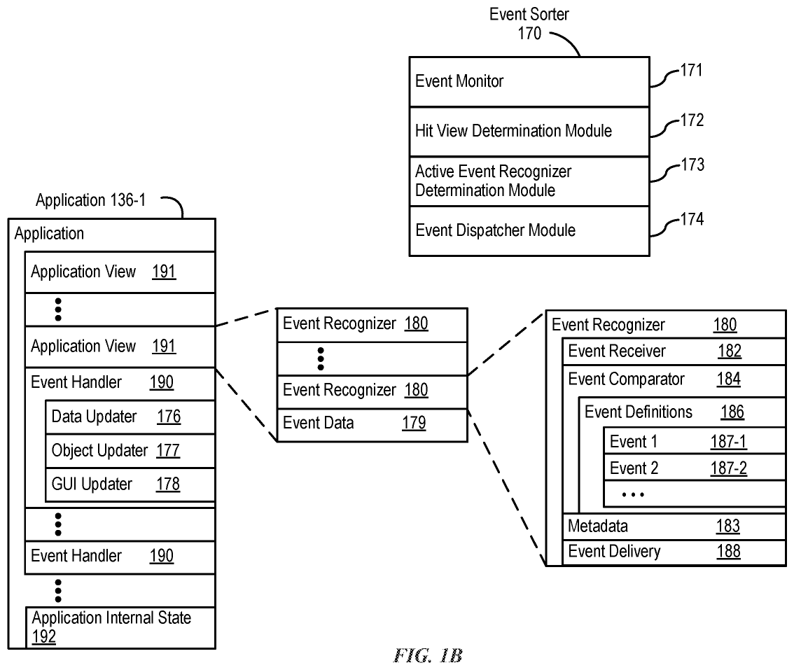

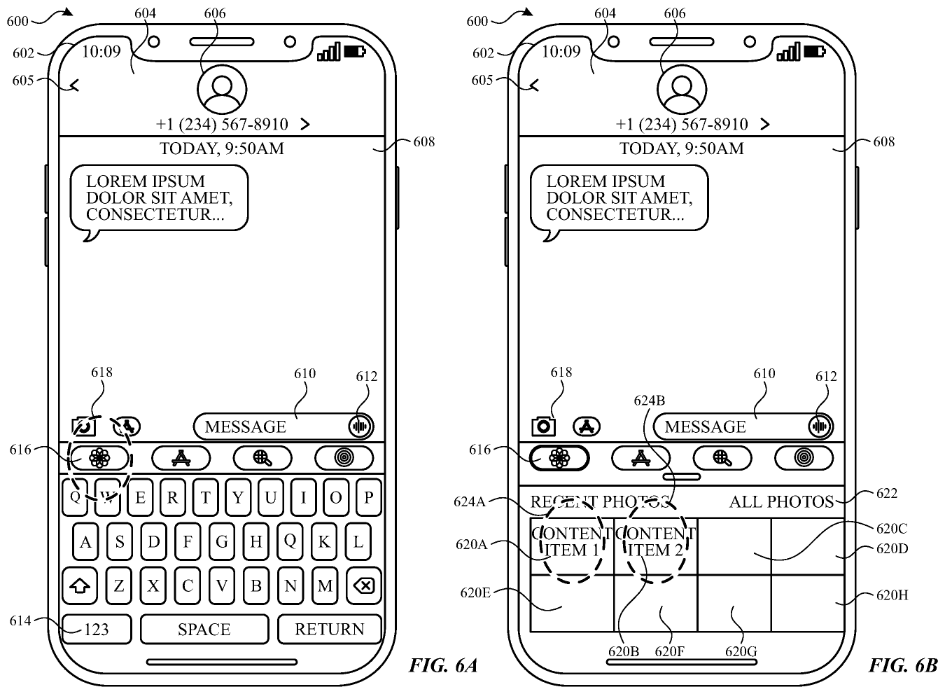

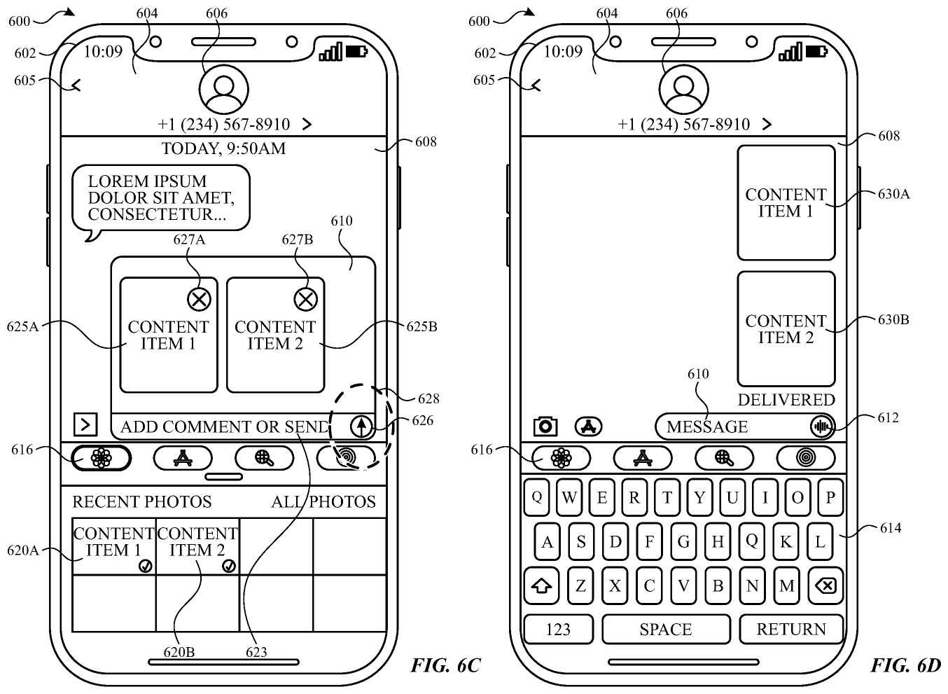

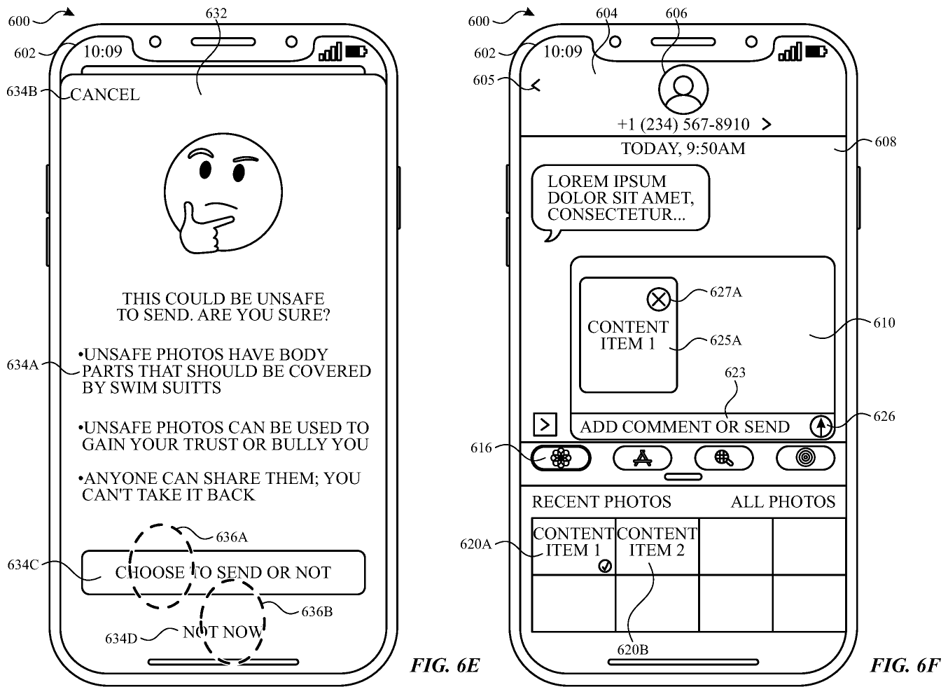

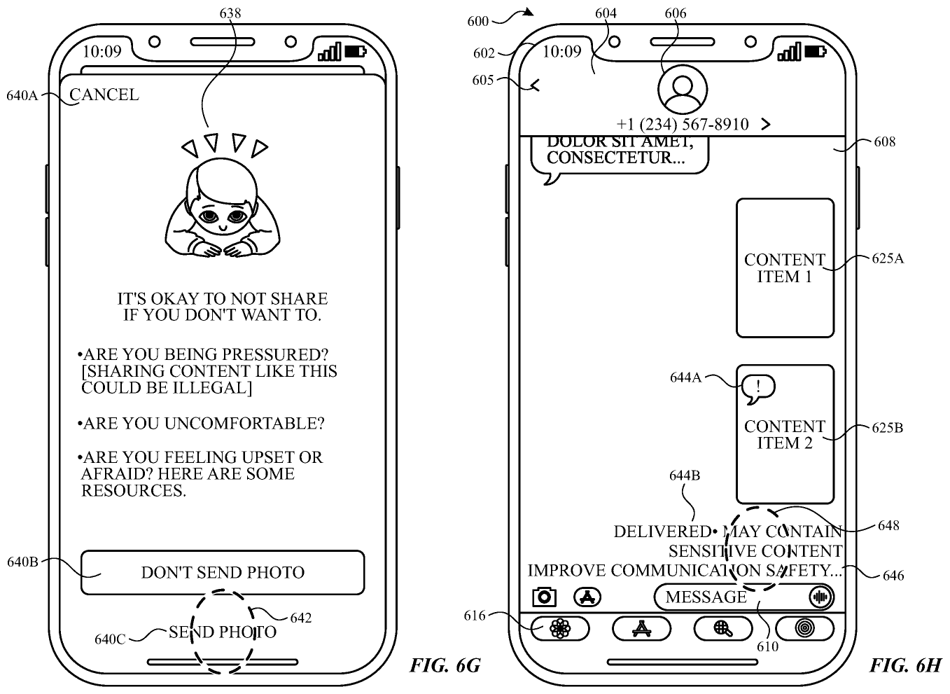

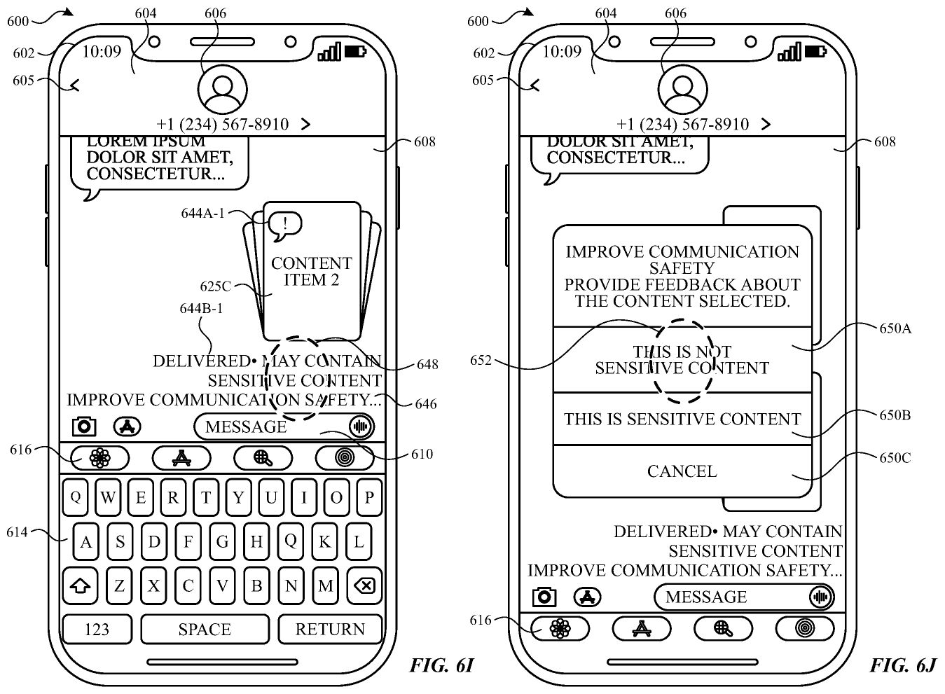

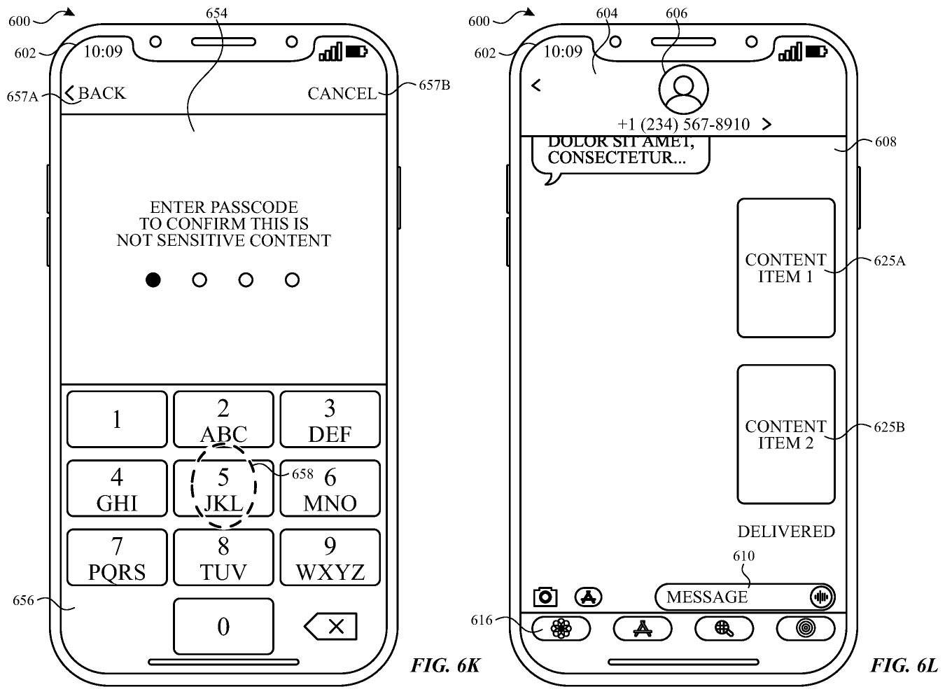

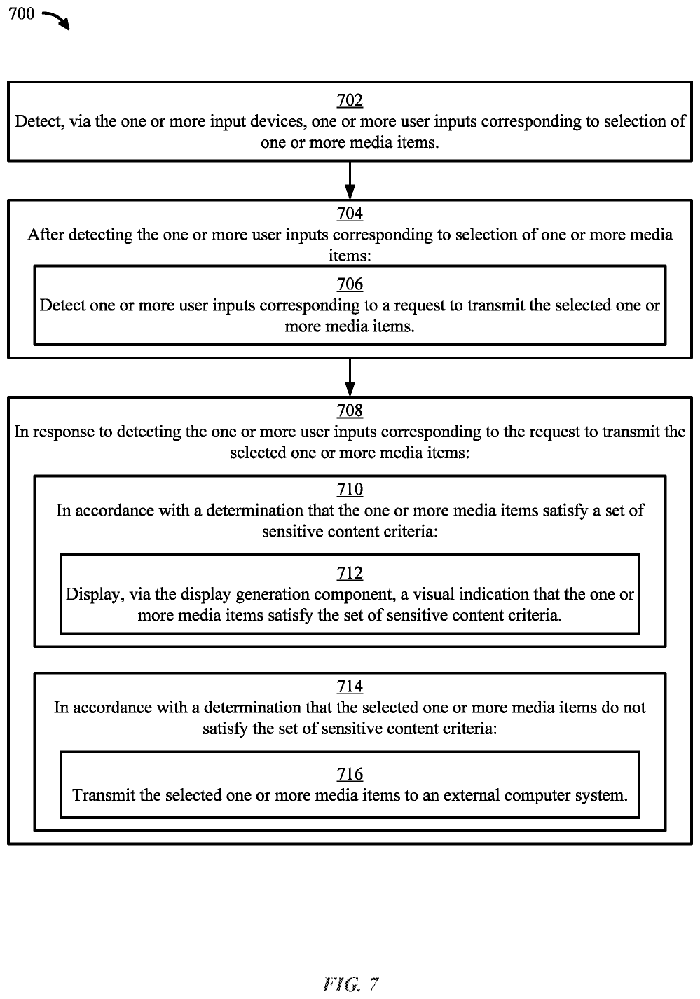

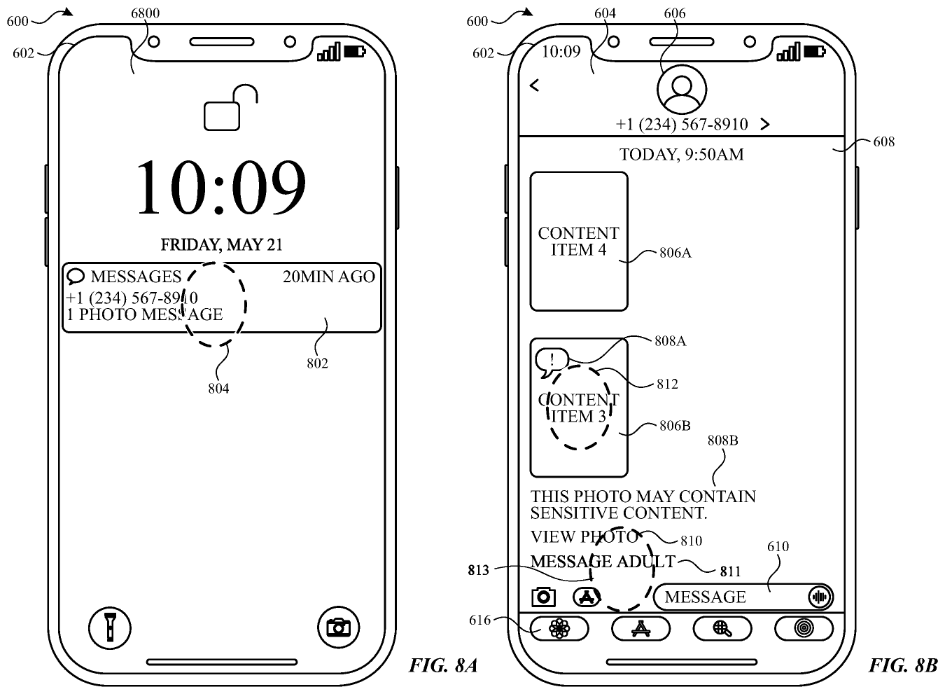

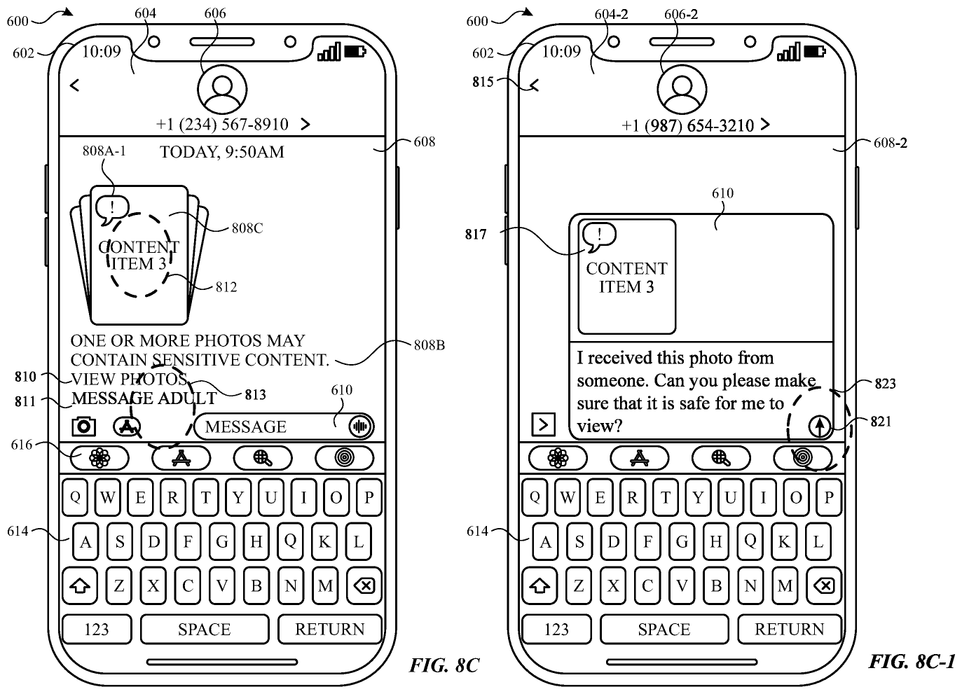

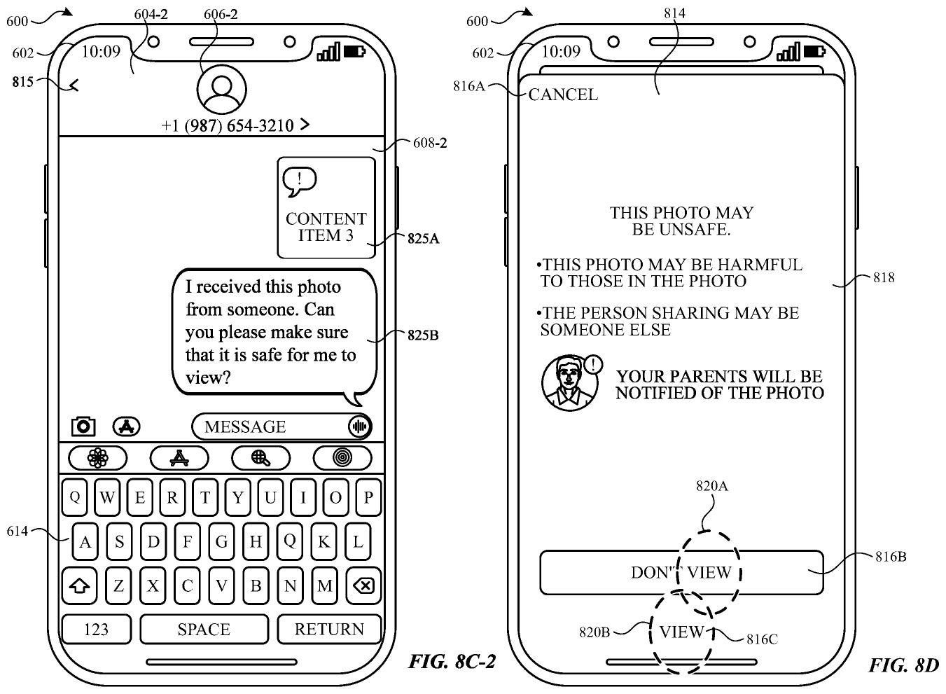

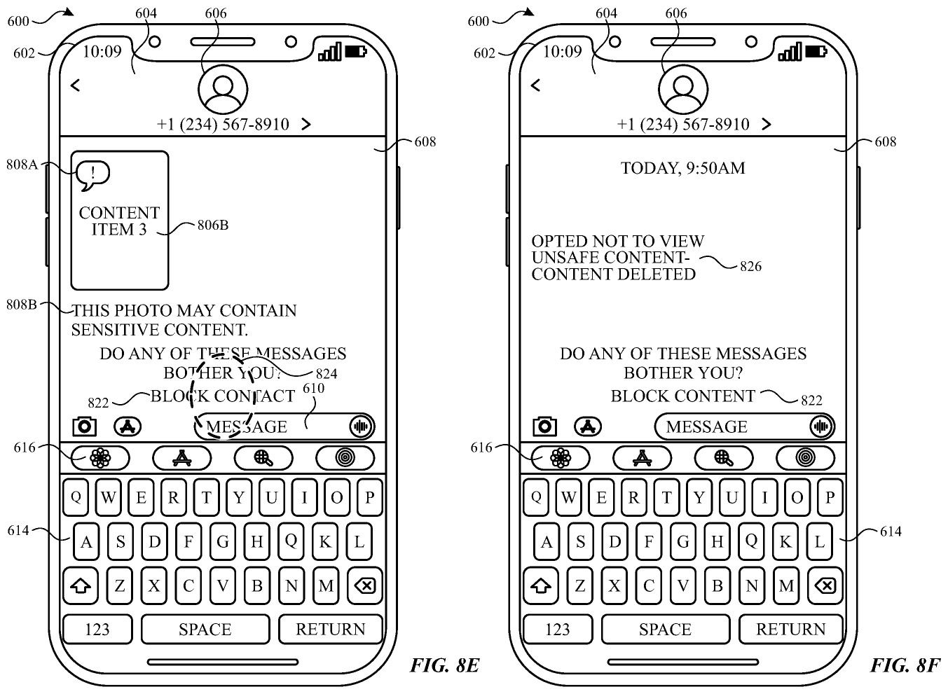

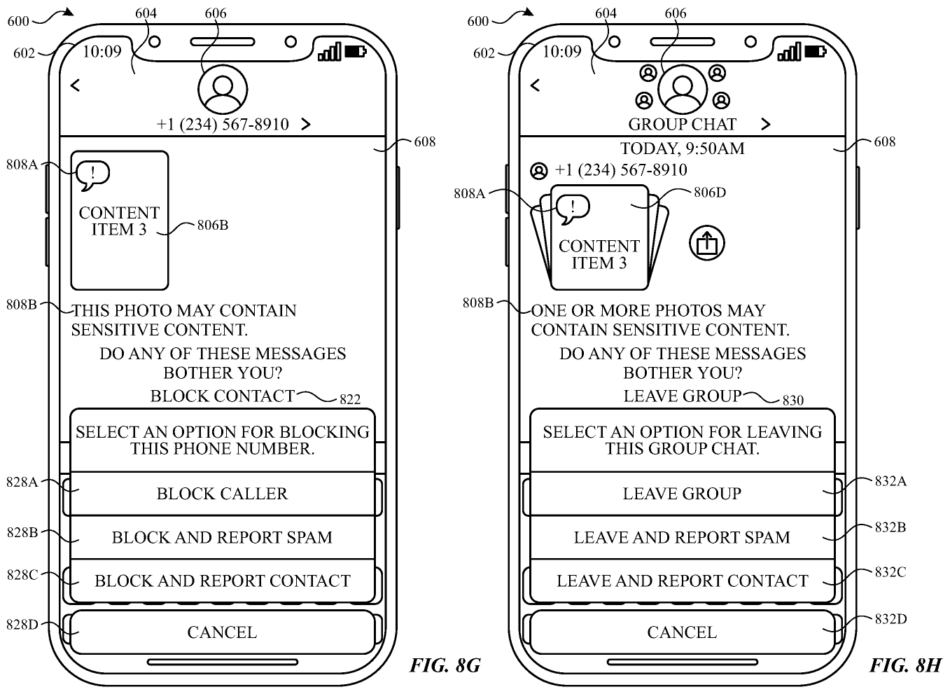

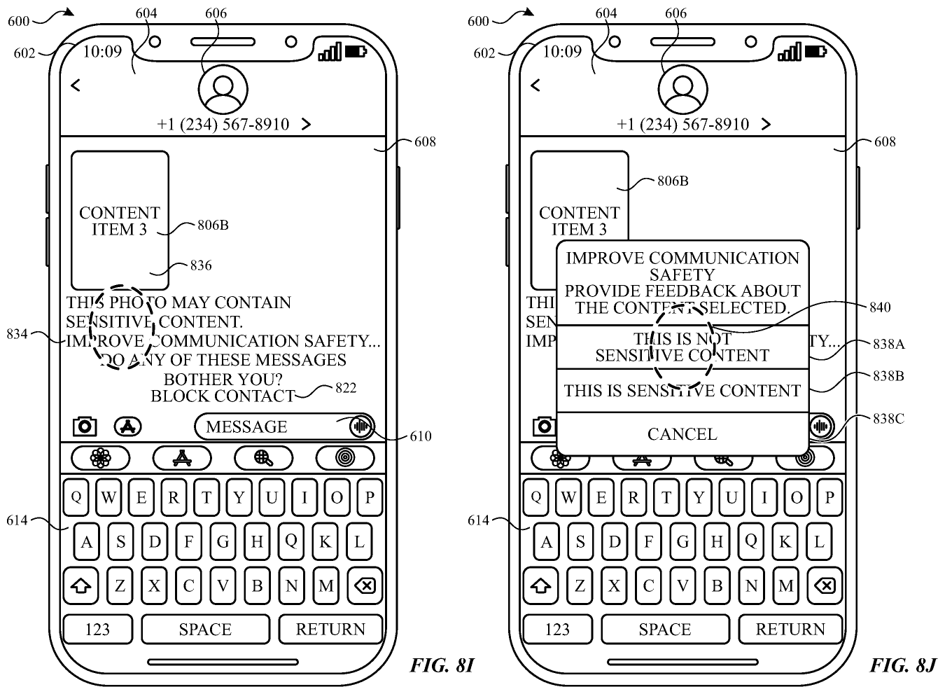

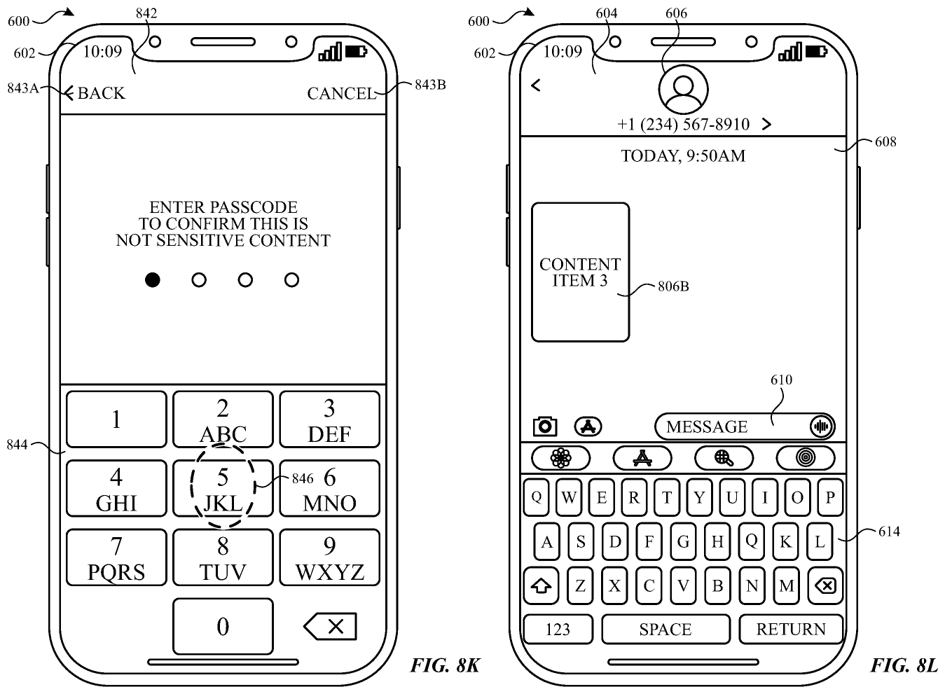

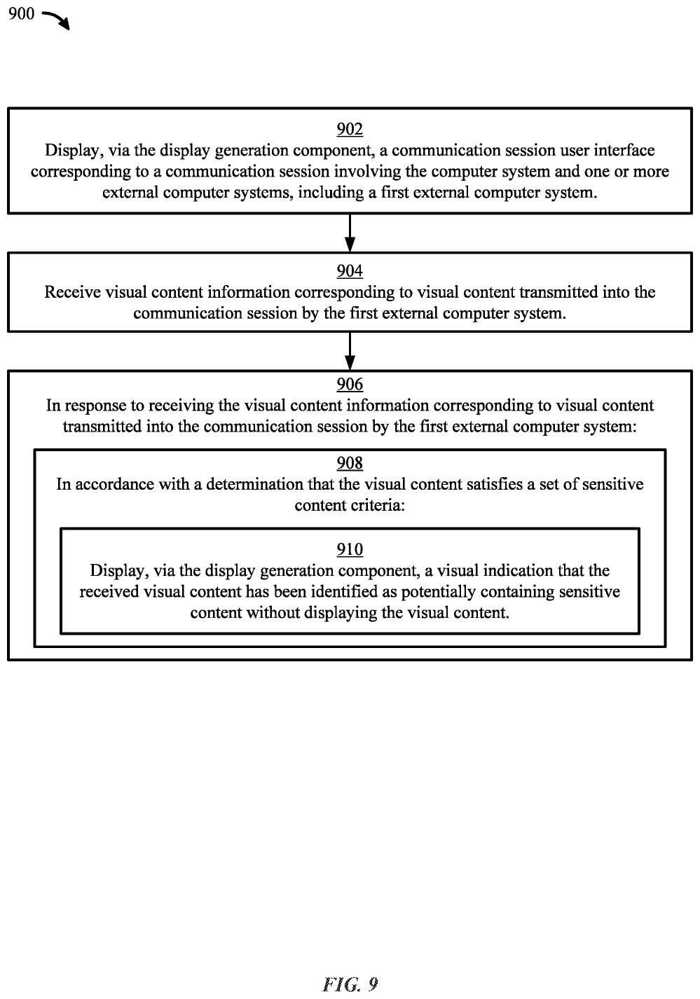

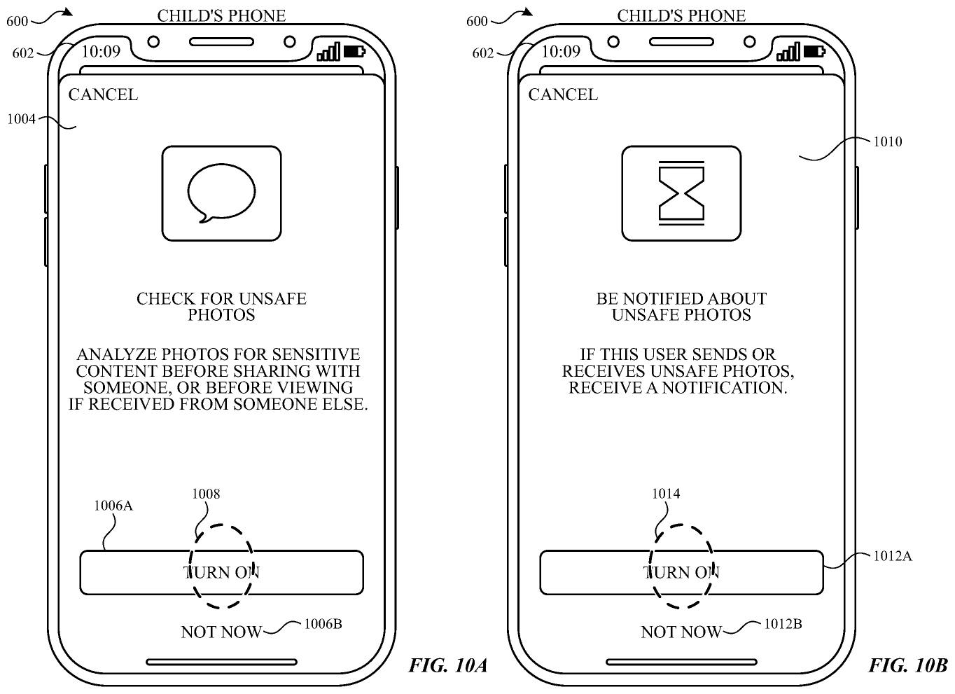

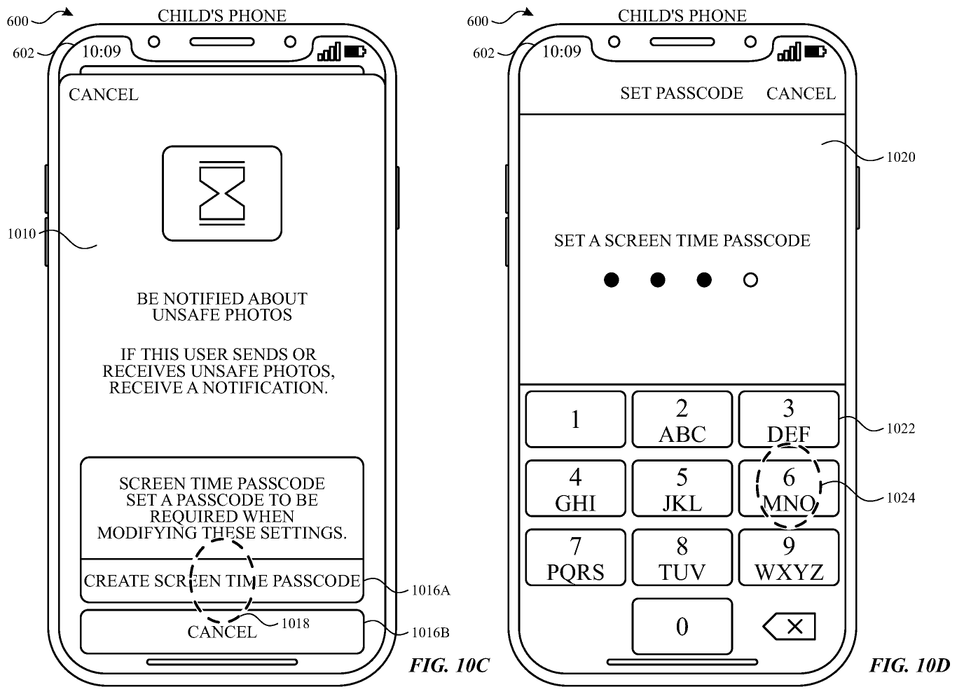

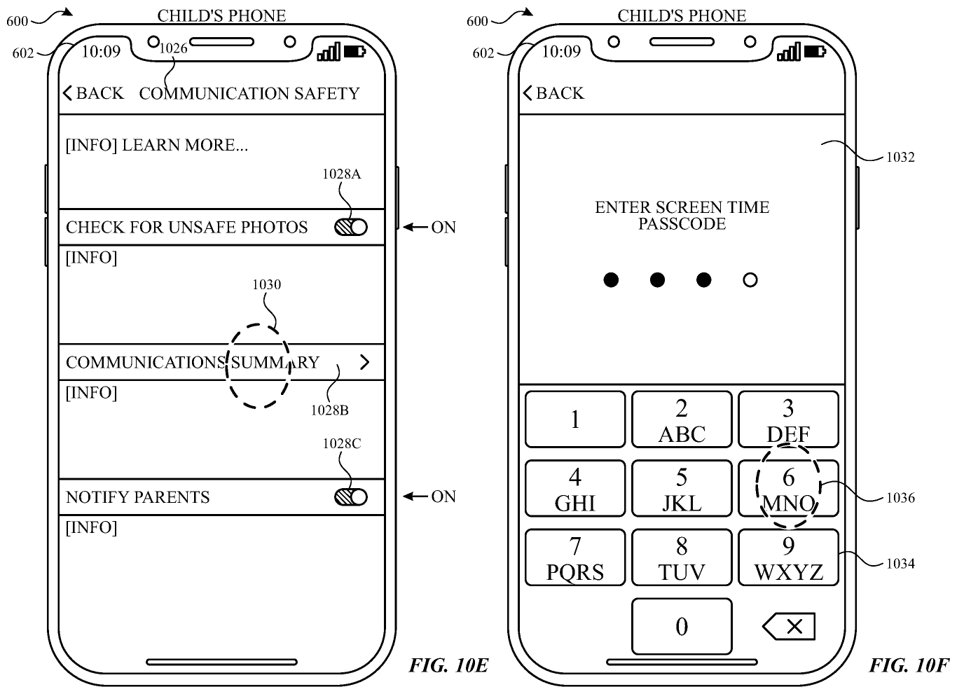

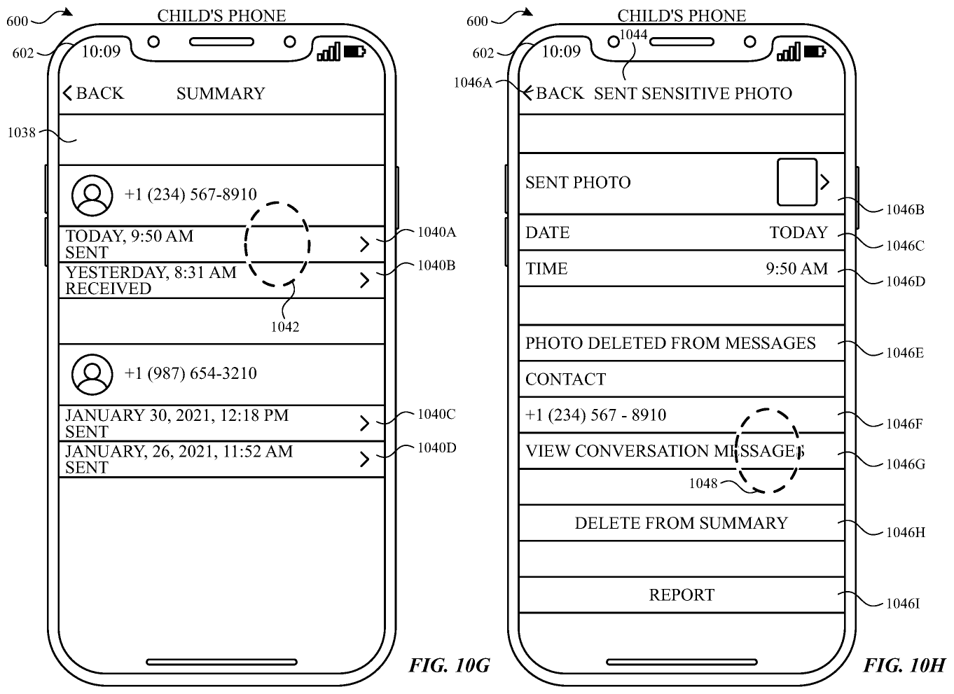

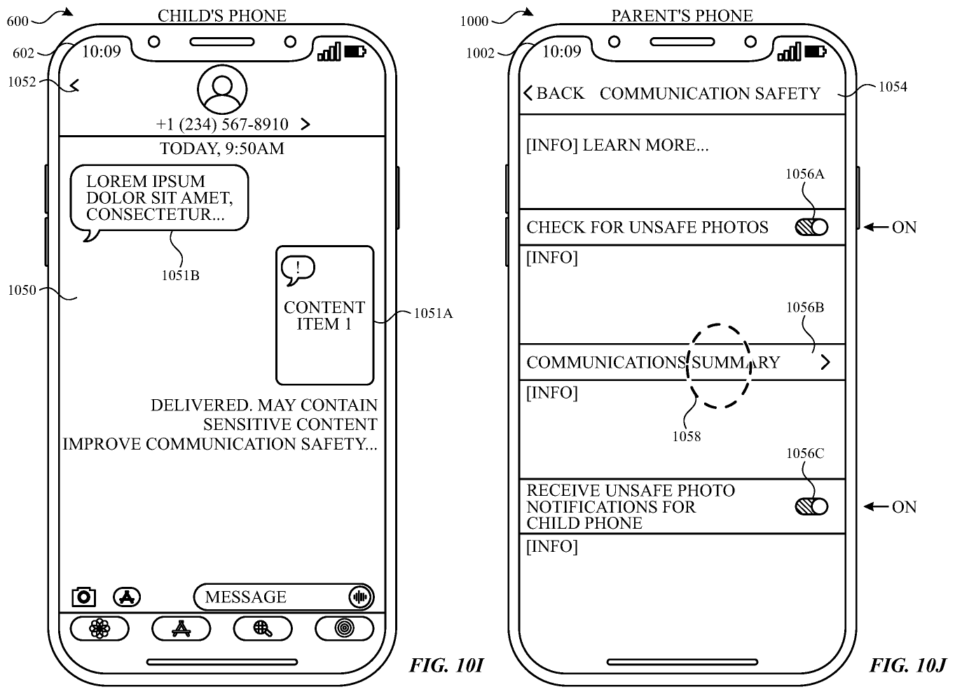

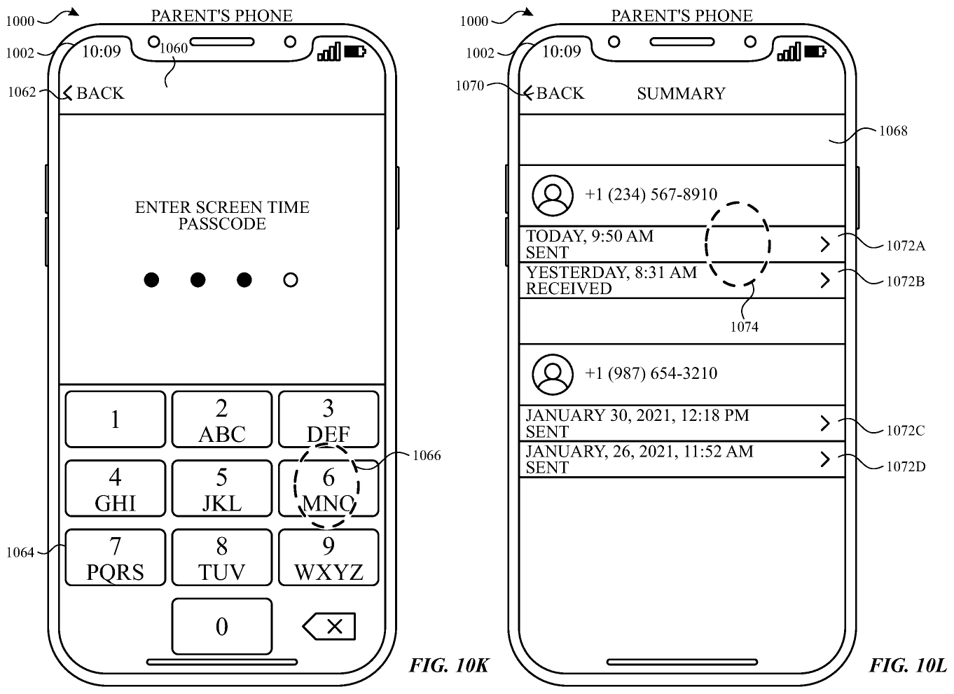

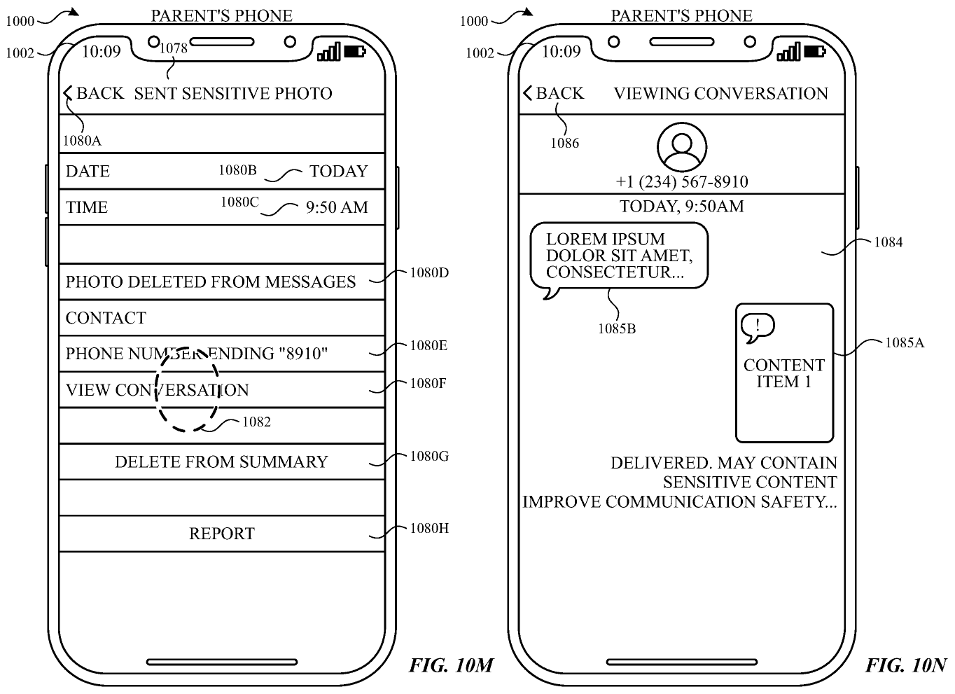

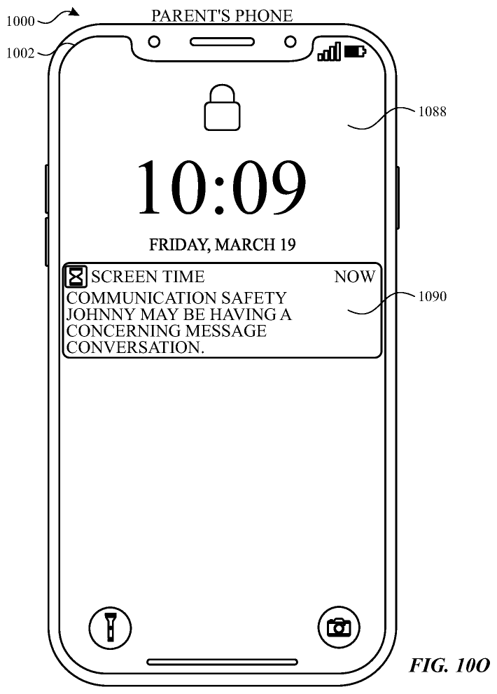

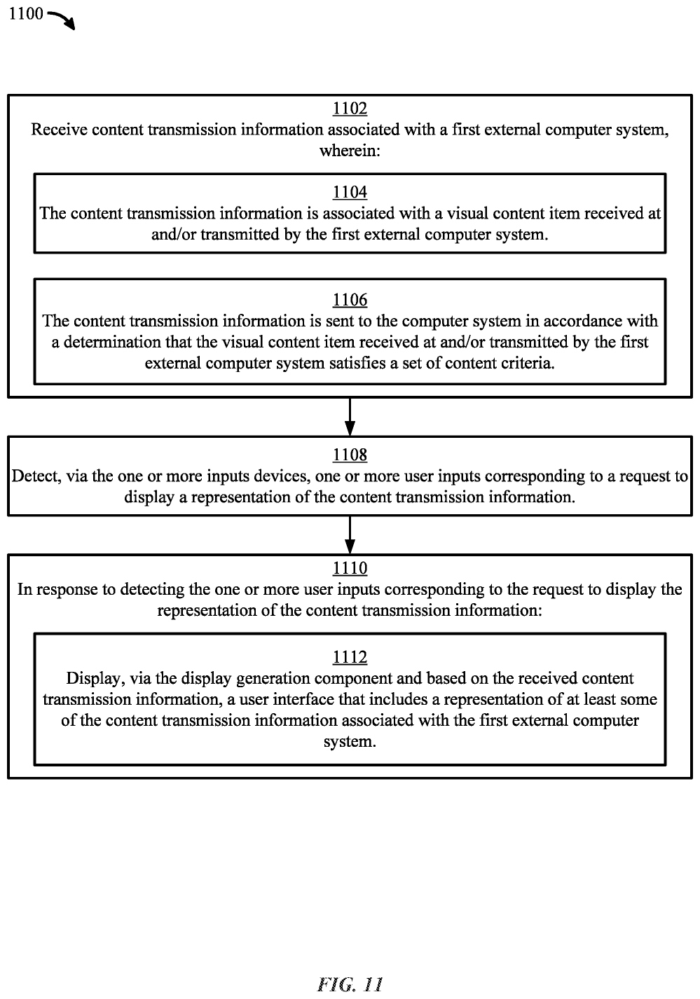

Below, FIGS. 1A-1B, 2, 3, 4A-4B, and 5A-5B provide a description of exemplary devices for performing the techniques for managing receipt and transmission of content. FIGS. 6A-6L illustrate exemplary user interfaces for managing transmission of content. FIG. 7 is a flow diagram illustrating methods of managing transmission of content in accordance with some embodiments. The user interfaces in FIGS. 6A-6L are used to illustrate the processes described below, including the processes in FIG. 7. FIGS. 8A-8L illustrate exemplary user interfaces for managing receipt of content. FIG. 9 is a flow diagram illustrating methods of managing receipt of content in accordance with some embodiments. The user interfaces in FIGS. 8A-8L are used to illustrate the processes described below, including the processes in FIG. 9. FIGS. 10A-10O illustrate exemplary user interfaces for managing receipt and transmission of content in accordance with some embodiments. The user interfaces in FIGS. 10A-10O are used to illustrate the processes described below, including the processes in FIG. 11.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving security, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, Calif. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

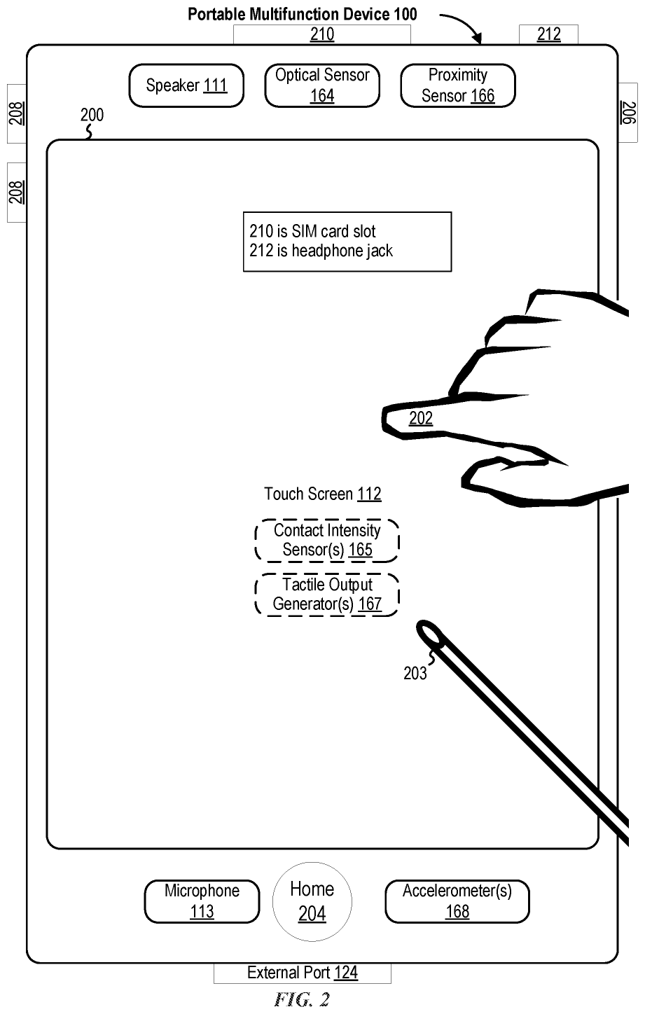

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, Calif.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

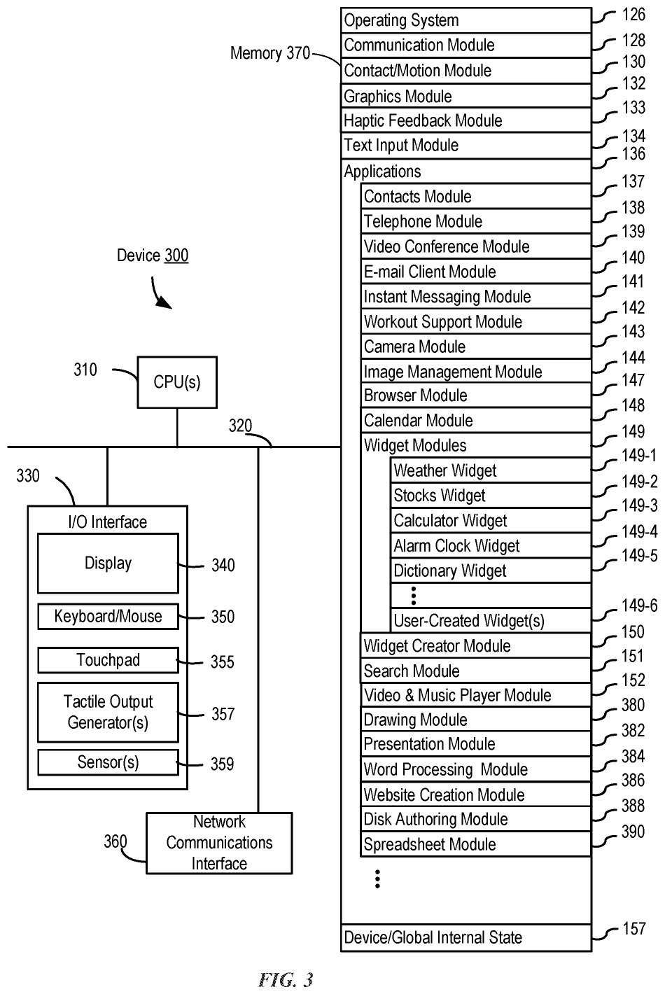

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

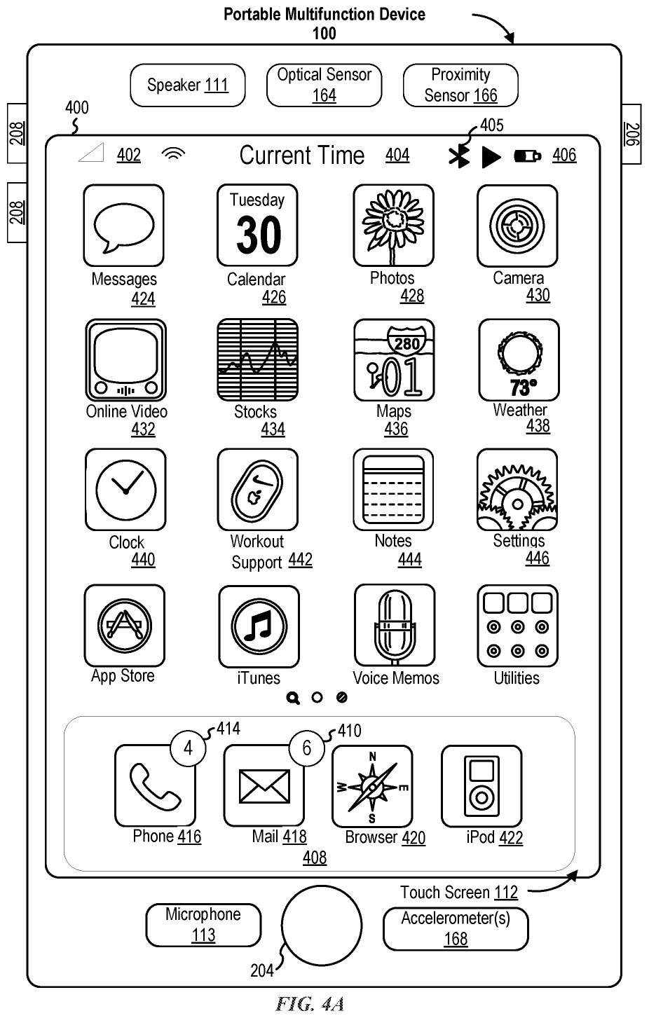

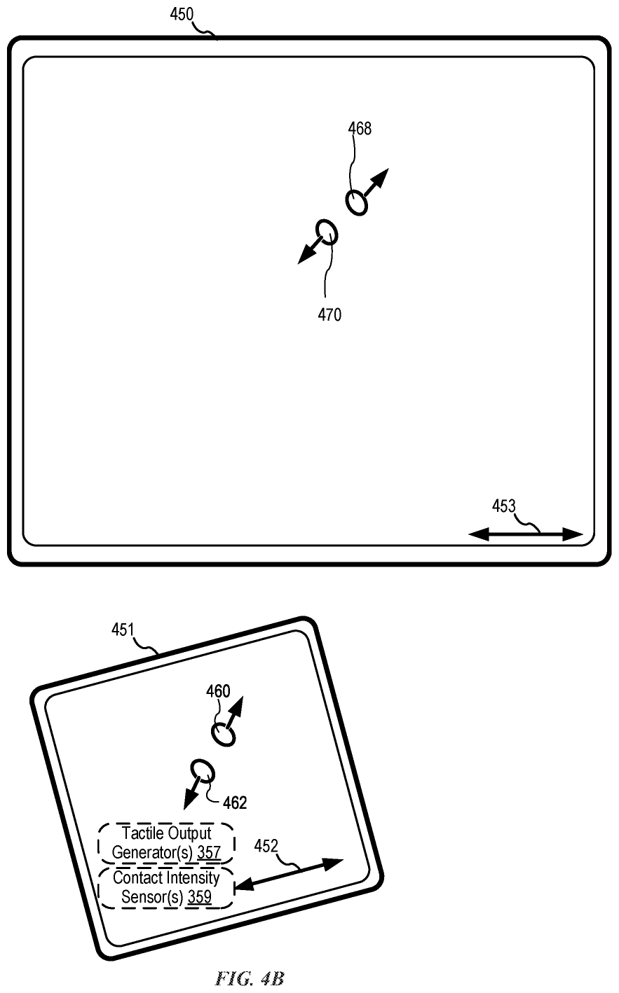

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

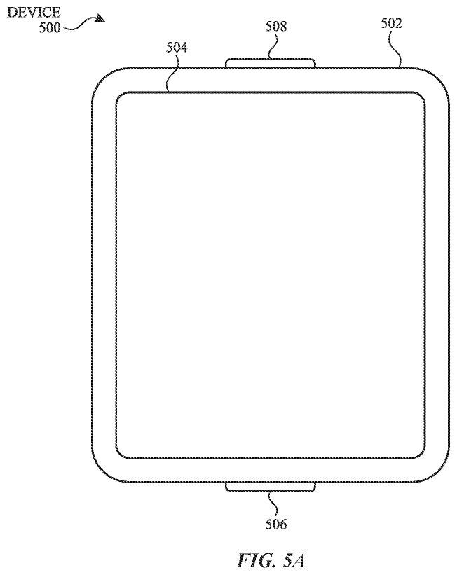

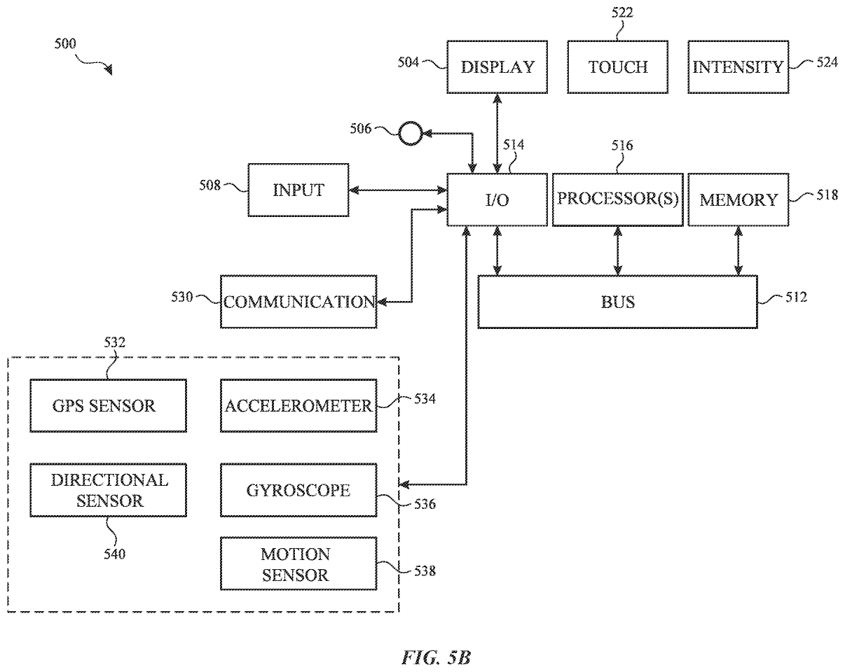

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700-1100 (FIGS. 7, 9, and 11). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

FIGS. 6A-6L illustrate exemplary user interfaces for managing transmission of content, in accordance with some embodiments. The user interfaces in these figures are used to illustrate the processes described below, including the processes in FIG. 7.

FIG. 6A depicts electronic device 600, which is a smartphone with touch-sensitive display 602. In some embodiments, electronic device 600 includes one or more features of devices 100, 300, and/or 500. Electronic device 600 depicts messaging user interface 604. Messaging user interface 604 in FIG. 6A corresponds to a first communication session between electronic device 600, and an external device that is identified by phone number (234) 567-8910. Messaging user interface 604 includes: back option 605 that is selectable to display a user interface that includes representations of a plurality of communication sessions including the first communication session; participant information 606, which identifies one or more participants in the communication session; message field 608 which includes a transcript of messages that have been transmitted into the communication session; draft message field 610 which displays a draft message being drafted on electronic device 600 but has not yet been transmitted into the communication session; audio input option 612 that is selectable to provide an audio input to be transcribed into draft message field 610; keyboard 614 for entering text into draft message field 610; and media option 616 that is selectable to identify one or more media items to be transmitted into the communication session. At FIG. 6A, electronic device 600 detects user input 618 corresponding to selection of media option 616.

At FIG. 6B, in response to user input 618, electronic device 600 displays representations of a plurality of media items (e.g., photos and/or videos) 620A-620H, and option 622 that is selectable to display representations of additional media items (e.g., representations of a plurality of media items (e.g., all media items) in a media library). In some embodiments, representations 620A-620H display previews (e.g., thumbnails) of their respective media items. At FIG. 6B, electronic device 600 detects user inputs 624A and 624B corresponding, respectively, to selection of representation 624A that is representative of a first media item (e.g., content item 1) and representation 624B that is representative of a second media item (e.g., content item 2).

At FIG. 6C, in response to user inputs 624A and 624B, electronic device 600 displays object 625A, representative of content item 1, and object 625B, representative of content item 2, within draft message field 610, respectively. Additionally, representations 620A and 620B are displayed with a check mark on the lower right hand corner indicating that they have been selected for transmission. In some embodiments, objects 625A and 625B display previews (e.g., thumbnails) of their respective corresponding media items. Each object 625A and 625B also includes a respective option, 627A and 627B, that is selectable to remove the object from draft message field 610 (e.g., and de-select its corresponding media item for transmission into the communication session). In response to content being entered into draft message field 610, electronic device 600 replaces audio input option 612 with send option 626, that is selectable to transmit content that is in draft message field 610 into the communication session. At FIG. 6C, electronic device 600 detects user input 628 corresponding to selection of send option 626.

FIG. 6D illustrates an example scenario in which neither content item 1 nor content item 2 is determined to satisfy a set of sensitive content criteria. In some embodiments, content items satisfy the set of sensitive content criteria if they are determined (e.g., using a machine learning model) to potentially depict sensitive content, such as inappropriate, lewd, offensive, or graphic content. In FIG. 6D, neither content item 1 nor content item 2 is determined to depict sensitive content. At FIG. 6D, in response to user input 628, and in accordance with a determination that neither content item 1 nor content item 2 satisfies the set of sensitive content criteria, electronic device 600 transmits content item 1 and content item 2 into the communication session, and representation 630A, representative of content item 1, and representation 630B, representative of content item 2, are displayed in message field 608. In some embodiments, representation 630A displays a preview (e.g., a thumbnail) of content item 1, and representation 630B displays a preview (e.g., a thumbnail) of content item 2.

FIGS. 6E-6L illustrate an alternative scenario in which content item 2 is determined to satisfy the set of sensitive content criteria (e.g., is determined to potentially depict sensitive content), while content item 1 does not satisfy the set of sensitive content criteria. At FIG. 6E, in response to user input 628 of FIG. 6C, and in accordance with a determination that content item 2 satisfies the set of sensitive content criteria, electronic device 600 forgoes transmitting content item 1 and content item 2 into the communication session, and displays user interface 632. User interface 632 includes notification 634A which explains that at least some of the content items that were submitted for transmission were identified as potentially containing sensitive content, and an explanation of what sensitive content can include. User interface 632 also includes cancel option 634B that is selectable to cancel transmission of content items 1 and 2 and return to messaging user interface 604 of FIG. 6C. User interface 632 also includes option 634C, that is selectable to proceed with transmitting content items 1 and 2 into the communication session, and option 634D that is selectable to cancel transmission of content items 1 and 2. FIG. 6E depicts electronic device 600 detecting user input 636A, corresponding to selection of option 634C, and user input 636B, corresponding to selection of option 634D. Each of these scenarios will be discussed in turn below.

At FIG. 6F, in response to detecting user input 636B corresponding to selection of option 634D in FIG. 6E, electronic device 600 re-displays messaging user interface 604. However, in FIG. 6F, because the user has selected option 634D (a selection not to transmit the two selected media items), electronic device 600 removes content item 2 from draft message field 610 because it satisfies the set of sensitive content criteria, and maintains content item 1 in draft message field 610 because it does not satisfy the set of sensitive content criteria. Representation 620B also indicates that content item 2 is no longer selected for transmission, while representation 620A indicates that content item 1 remains selected. From FIG. 6F, a user can provide a user input selection send option 626 to transmit content item 1 into the communication session. In the depicted example scenario and embodiment, content item 1 would then be transmitted into the communication session (e.g., without any further steps, user inputs, and/or further display of other user interfaces), as content item 1 does not satisfy the set of sensitive content criteria.

At FIG. 6G, in response to detecting user input 636A corresponding to selection of option 636C in FIG. 6E, electronic device 600 displays user interface 638. User interface 638 includes cancel option 640A that is selectable to cancel transmission of content items 1 and 2 and return to messaging user interface 604 of FIG. 6C. User interface 638 also includes option 640B, that is selectable to forgo transmitting sensitive content (e.g., forgo transmitting content item 2), and option 640C that is selectable to proceed with transmitting the detected sensitive content (e.g., proceed with transmitting content item 2, along with content item 1). At FIG. 6G, electronic device 600 detects user input 642 corresponding to selection of option 640C.

At FIG. 6H, in response to user input 642, electronic device 600 transmits content item 1 and content item 2 into the communication session, and message field 608 depicts object 625A, representative of content item 1, and object 625B, representative of content item 2. In some embodiments, objects 625A and 625B depict previews (e.g., thumbnails) of content items 1 and 2, respectively. However, in some embodiments, at other devices participating in the communication session, an object and/or representation representative of content item 2 does not initially display a preview of content item 2 in accordance with a determination that content item 2 satisfies the set of sensitive content criteria, as will be described in greater detail below with reference to FIGS. 8A-8L. Furthermore, in FIG. 6H, object 625B corresponding to content item 2 is displayed with indications 644A and 644B indicating that content item 2 has been determined to satisfy the set of sensitive content criteria. Furthermore, in accordance with a determination that content item 2 satisfies the set of sensitive content criteria, messaging user interface 646 includes option 646 corresponding to object 625B. Option 646 can be selected by a user so that the user can indicate whether or not content item 2 does, in fact, depict sensitive content.

FIG. 6I depicts an alternative embodiment of FIG. 6H. In FIG. 6I, rather than displaying representations of content items 1 and 2 separately (e.g., objects 625A and 625B in FIG. 6H), in FIG. 6I, representation 625C is representative of both content items 1 and 2 (e.g., representative of all content items (e.g., media items) that were transmitted into the communication session in response to user input 642 of FIG. 6G). In accordance with a determination that at least one of the transmitted media items content item 1 and content item 2 satisfy the set of sensitive content criteria, electronic device 600 displays representation 625C with indications 644A-1 and 644B-1, and option 648, indicating that at least one of the transmitted media items was determined to satisfy the set of sensitive content criteria.

In FIGS. 6H and 6I, electronic device 600 detects user input 648 corresponding to selection of option 646.

At FIG. 6J, in response to user input 648, electronic device 600 displays option 650A, that is selectable to indicate that content item 2 does not include sensitive content, option 650B that is selectable to indicate that content item 2 does include sensitive content, and option 650C that is selectable to return to messaging user interface 604 without indicating whether content item 1 includes sensitive content. At FIG. 6J, electronic device 600 detects user input 652 corresponding to selection of option 650A.

At FIG. 6K, in response to user input 652, electronic device 600 displays authentication user interface 654. In some embodiments, in order to indicate that a media item that is determined to satisfy the set of sensitive content criteria does not depict sensitive content, a user must enter a passcode to ensure that the user is authorized to make such determinations. At FIG. 6K, electronic device 600 detects user input 658 corresponding to entry of authentication information via keypad 656.

At FIG. 6L, in accordance with a determination that the user has provided valid authentication information, electronic device 600 displays messaging user interface 604 in which indications 644A and 644B have been removed from object 625B representative of content item 2. In some embodiments, user inputs on options 650A and 650B in FIG. 6J are used to train and improve a machine learning model that is designed to identify media items that depict sensitive content. For example, in FIGS. 6J-6L, based on user input 652 and successful authentication in FIG. 6K, in some embodiments, a machine learning model is trained and/or updated based on the feedback that content item 2 does not depict sensitive content.

FIG. 7 is a flow diagram illustrating a method for managing transmission of content using a computer system in accordance with some embodiments. Method 700 is performed at a computer system (e.g., 100, 300, 500, 600, or 1000) (e.g., a smart phone, a smart watch, and/or a tablet) that is in communication with a display generation component (e.g., a display controller; a touch-sensitive display system; and/or a display (e.g., integrated and/or connected)) and one or more input devices (e.g., a touch-sensitive surface (e.g., a touch-sensitive display); a mouse; a keyboard; and/or a remote control). In some embodiments, the computer system displays, via the display generation component, a user interface comprising representations of a plurality of media items (e.g., photos and/or videos). In some embodiments, the representations of the plurality of media items includes thumbnails of the plurality of media items. Some operations in method 700 are, optionally, combined, the orders of some operations are, optionally, changed, and some operations are, optionally, omitted.

As described below, method 700 provides an intuitive way for managing transmission of content. The method reduces the cognitive burden on a user for managing transmission of content, thereby creating a more efficient human-machine interface. For battery-operated computing devices, enabling a user to manage transmission of content faster and more efficiently conserves power and increases the time between battery charges.

The computer system (e.g., 600) detects (702), via the one or more input devices, one or more user inputs (e.g., 624A and/or 624B) (e.g., one or more tap inputs and/or one or more non-tap inputs) corresponding to selection of one or more media items (e.g., 620A and/or 620B). In some embodiments, the computer system detects selection of one or more media items of a plurality of media items.

After detecting the one or more user inputs corresponding to selection of one or more media items (704), the computer system detects (706), via the one or more input devices, one or more user inputs (e.g., 628) corresponding to a request to transmit the selected one or more media items (e.g., to one or more external computer systems) (e.g., into a communication session (e.g., audio, video, and/or text-based communication session) with one or more external computer systems).

In response to detecting the one or more user inputs corresponding to the request to transmit the selected one or more media items (708): in accordance with a determination that the one or more media items satisfy a set of sensitive content criteria (710) (e.g., a single media item of the one or more media items satisfy the set of sensitive content criteria and/or more than one media item of the one or more media items satisfy the set of sensitive content criteria) (e.g., the set of sensitive content criteria are indicative of at least one of the one or more media items potentially containing sensitive content (e.g., inappropriate content, graphic content, and/or illegal content) (e.g., based on one or more machine learning models)) (e.g., in accordance with a determination that at least some of the selected one or more media items potentially contain sensitive content), the computer system displays (712), via the display generation component, a visual indication (e.g., 632, 634A, 638, 644A, and/or 644B) that the one or more media items satisfy the set of sensitive content criteria (e.g., a visual indication that one or more of the one or more media items satisfy the set of sensitive content criteria) (e.g., a visual indication that one or more of the one or more media items potentially contain sensitive content) (e.g., prior to and/or without transmitting the one or more media items (e.g., forgoing transmitting the one or more media items until one or more additional user inputs confirming the request to transmit the one or more media items is received)) (e.g., prior to and/or without transmitting the first media item (e.g., forgoing transmitting the first media item until one or more additional user inputs confirming the request to transmit the first media item is received)); and in accordance with a determination that the selected one or more media items do not satisfy the set of sensitive content criteria (714) (e.g., in accordance with a determination that the selected one or more media items do not contain sensitive content) (e.g., based on one or more machine learning models), the computer system transmits (716) the selected one or more media items to an external computer system (e.g., 630A and/or 630B in FIG. 6D) (e.g., one or more external computer systems) (e.g., one or more external computer systems participating in a communication session (e.g., audio, video, and/or text-based communication session) with the computer system) (e.g., without displaying the visual indication that the one or more media items have been identified as potentially containing sensitive content). Displaying the visual indication that the one or more media items satisfy the set of sensitive content criteria in accordance with a determination that the one or more media items satisfy the set of sensitive content criteria provides the user with feedback about the current state of the device (e.g., that the device has determined that at least some of the one or more media items satisfy the set of sensitive content criteria). Providing improved feedback to the user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently. The device also provides enhanced usability to a user by marking potentially sensitive content and notifying the user prior to sending without the user having to take any additional action.

In some embodiments, the visual indication that the one or more media items satisfy the set of sensitive content criteria includes an explanation (e.g., 632 and/or 634A) (e.g., text and/or image) of why the one or more media items satisfy the set of sensitive content criteria (e.g., an explanation of the set of sensitive content criteria and/or one or more criteria of the set of sensitive content criteria, an explanation of what constitutes sensitive content, and/or an explanation of why one or more media items of the one or more media items have been identified as potentially containing and/or depicting sensitive content). Displaying an explanation of why the one or more media items satisfy the set of sensitive content criteria provides the user with feedback about the current state of the device (e.g., feedback about why the device has determined that at least some of the one or more media items satisfy the set of sensitive content criteria). Providing improved feedback to the user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, displaying the visual indication that the one or more media items satisfy the set of sensitive content criteria includes displaying a first selectable object (e.g., 634C or 640C) that is selectable to confirm user intent to transmit the one or more media items (e.g., despite the one or more media items satisfying the set of sensitive content criteria) (e.g., a first selectable object that is selectable to initiate and/or further the process of transmitting the selected one or more media items to an external computer system). In some embodiments, the computer system displays, concurrently with the first selectable object, a second selectable object that is selectable to cancel transmission of the one or more media items. Displaying a first selectable object that is selectable to confirm user intent to transmit the one or more media items provides feedback to the user about the current state of the device and feedback as to how the user can proceed with transmitting the one or more media items. Providing improved feedback to the user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, while displaying the first selectable object (e.g., 634C or 640C), the computer system detects, via the one or more input devices, one or more user inputs (e.g., 636A or 642) (e.g., one or more tap inputs and/or one or more non-tap inputs) corresponding to selection of the first selectable object. In response to detecting the one or more inputs corresponding to selection of the first selectable object, the computer system transmits the selected one or more media items (e.g., 625A and/or 625B in FIG. 6H) to the external computer system (e.g., one or more external computer systems) (e.g., one or more external computer systems participating in a communication session (e.g., audio, video, and/or text-based communication session) with the computer system). In some embodiments, in response to detecting the one or more inputs corresponding to selection of the first selectable object, the computer system furthers a process for transmitting the selected one or more media items to the external computer system (e.g., displays a user interface for transmitting the selected one or more items to the external computer system). In some embodiments, after transmitting the selected one or more media items to the external computer, the computer system displays, via the display generation component, an indication that the one or more media items have been transmitted to the external computer. In some embodiments, the computer system displays, concurrently with the indication that the one or more media items have been transmitted to the external computer, an indication that the one or more media items satisfy the set of sensitive content criteria (e.g., an indication that the one or more media items may include and/or depict sensitive content). Transmitting the one or more media items in response to a user input provides the user with the ability to transmit content even when the content is determined to satisfy the set of sensitive content criteria. Providing additional control of the device enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently. Requiring an additional user input to transmit content that has been determined to satisfy the set of sensitive content criteria provides security and can prevent unintentional transmission of sensitive content. Providing improved security enhances the operability of the device and makes the user-device interface more efficient and/or secure (e.g., by restricting unauthorized access) which, additionally, reduces power usage and improves battery life of the device by limiting the performance of restricted operations.

In some embodiments, transmitting the selected one or more media items to the external computer system in response to detecting the one or more inputs (e.g., 636A and/or 642) corresponding to selection of the first selectable object causes a second external computer system (e.g., 1000) (e.g., a second external computer system different from the external computer system) to receive a notification (e.g., 1090) (e.g., display a notification) that the computer system (e.g., 600) has transmitted content that satisfies the set of sensitive content criteria (e.g., a notification that the computer system has transmitted content that was identified as potentially containing and/or depicting sensitive content). In some embodiments, the second external computer system is a computer system that has been identified as belonging to and/or corresponding to a parent and/or guardian of a user of the computer system. Causing a second external computer system to receive a notification that the computer system has transmitted content that satisfies the set of sensitive content criteria provides security and can notify users of unauthorized and/or undesirable transmission of sensitive content. Providing improved security enhances the operability of the device and makes the user-device interface more efficient and/or secure (e.g., by restricting unauthorized access) which, additionally, reduces power usage and improves battery life of the device by limiting the performance of restricted operations.

In some embodiments, transmitting the selected one or more media items to the external computer system in response to detecting the one or more inputs (e.g., 636Ad and/or 642) corresponding to selection of the first selectable object causes a third external computer system (e.g., 1000) (e.g., the second external computer system) (e.g., a third external computer system different from the external computer system) to receive information pertaining to the transmitted content (e.g., transmission instances 1040A, 1040B, 1040C, or 1040D; information 1046B-1046G in user interface 1044) (e.g., one or more recipients of the content (e.g., names, phone numbers, email addresses, and/or usernames), a copy of the content, and/or date/time content was transmitted). In some embodiments, the computer system stores (e.g., locally on the computer system) the information pertaining to the transmitted content that is received at the third external computer system. In some embodiments, the information pertaining to the transmitted content received at the third external computer system does not include a copy of the one or more media items. In some embodiments, the computer system does store a copy of the one or more media items. In some embodiments, the information pertaining to the transmitted content is displayed on the third external computer system (e.g., in response to one or more user inputs received at the third external computer system). In some embodiments, the information pertaining to the transmitted content can be displayed at the computer system (e.g., in response to one or more user inputs received at the computer system). In some embodiments, the third external computer system is a computer system that has been identified as belonging to and/or that is logged into a user account corresponding to a parent and/or guardian of a user of the computer system. Causing a third external computer system to receive information pertaining to transmitted content transmitted by the computer system that satisfies the set of sensitive content criteria provides security and can notify users of unauthorized and/or undesirable transmission of sensitive content. Providing improved security enhances the operability of the device and makes the user-device interface more efficient and/or secure (e.g., by restricting unauthorized access) which, additionally, reduces power usage and improves battery life of the device by limiting the performance of restricted operations.

In some embodiments, after transmitting the selected one or more media items (e.g., 625A and/or 625B) to the external computer system, the computer system displays, via the display generation component, a second selectable object (e.g., 646) that is selectable to initiate a process for a user to indicate that the one or more media items do not depict sensitive content (e.g., FIGS. 6H-6L). In some embodiments, one or more user inputs indicating that the one or more media items do not depict sensitive content are used to train and/or update a machine learning model. In some embodiments, the computer system, while displaying the second selectable object, detects, via the one or more input devices, one or more user inputs (e.g., one or more tap inputs and/or one or more non-tap inputs) corresponding to selection of the second selectable object; in response to detecting the one or more user inputs corresponding to selection of the second selectable object, the computer system displays, via the display generation component, a third selectable object that is selectable to indicate that the one or more media items do not depict sensitive content; while displaying the third selectable object, the computer system detects, via the one or more input devices, one or more user inputs (e.g., one or more tap inputs and/or one or more non-tap inputs) corresponding to selection of the third selectable object; and in response to detecting the one or more user inputs corresponding to selection of the third selectable object, the computer system ceases to display an indication that the one or more media items may depict sensitive content. Providing users with the ability to indicate that the one or more media items do not depict sensitive content improves security by providing means for improving on the set of sensitive content criteria (e.g., improving a machine learning model that identifies sensitive content). Providing improved security enhances the operability of the device and makes the user-device interface more efficient and/or secure (e.g., by restricting unauthorized access) which, additionally, reduces power usage and improves battery life of the device by limiting the performance of restricted operations.

In some embodiments, while displaying the second selectable object (e.g., 646), the computer system detects, via the one or more input devices, one or more user inputs (e.g., 648) (e.g., one or more tap inputs and/or one or more non-tap inputs) corresponding to selection of the second selectable object. Subsequent to detecting the one or more user inputs (e.g., 648) corresponding to selection of the second selectable object (e.g., 646) (e.g., in response to detecting the one or more user inputs corresponding to selection of the second selectable object), the computer system (e.g., 600) displays, via the display generation component, an authentication user interface (e.g., 654) that prompts a user to provide authentication information (e.g., a password entry user interface requesting entry of a user password and/or a PIN entry user interface requesting entry of a user PIN). In some embodiments, displaying the authentication user interface subsequent to detecting the one or more user inputs corresponding to selection of the second selectable object includes: in response to detecting the one or more user inputs corresponding to selection of the second selectable object, displaying, via the display generation component, a third selectable object that is selectable to indicate that the one or more media items do not contain and/or depict sensitive content; while displaying the third selectable object, detecting, via the one or more input devices, one or more user inputs (e.g., one or more tap inputs and/or one or more non-tap inputs) corresponding to selection of the third selectable object; and in response to detecting the one or more user inputs corresponding to selection of the third selectable object, displaying the authentication user interface. In some embodiments, while displaying the authentication user interface, the computer system receives, via the one or more input devices, authentication information; in response to receiving the authentication information: in accordance with a determination that the authentication information satisfies a set of authentication criteria (e.g., an entered PIN matches a stored PIN and/or an entered password matches a stored password), the computer system ceases to display an indication that the transmitted one or more media items satisfy the set of sensitive content criteria (e.g., ceasing to display an indication that the transmitted one or more media items may potentially depict and/or contain sensitive content). Displaying an authentication user interface requesting authentication information in response to detecting one or more user inputs corresponding to selection of the second selectable object provides security and can prevent unauthorized users from initiating sensitive operations. Providing improved security enhances the operability of the device and makes the user-device interface more efficient and/or secure (e.g., by restricting unauthorized access) which, additionally, reduces power usage and improves battery life of the device by limiting the performance of restricted operations.

In some embodiments, displaying the visual indication (e.g., 632 and/or 638) that the one or more media items satisfy the set of sensitive content criteria includes displaying (e.g., concurrently with the first selectable object) a third selectable object (e.g., 634D and/or 640B) that is selectable to cancel transmission of the one or more media items (e.g., cancel transmission of a subset of the one or more media items that satisfy the set of sensitive content criteria). Displaying the third selectable object that is selectable to cancel transmission of the one or more media items enables a user to quickly cancel transmission of the one or more media items, thereby reducing the number of inputs needed to cancel transmission of the one or more media items. Reducing the number of inputs needed to perform an operation enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, prior to detecting the one or more user inputs corresponding to selection of one or more media items, the computer system displays, via the display generation component, representations (e.g., 620A-620H) of (e.g., tiles and/or thumbnails) a plurality of media items (e.g., a plurality of media items of a media library (e.g. a media library stored on and/or associated with the computer system) (e.g., a media library of media items captured by and/or otherwise associated with a user of the computer system and/or captured by the computer system)). In some embodiments, each representation is representative of a respective media item of the plurality of media items. In some embodiments, detecting the one or more user inputs corresponding to selection of one or more media items includes: while displaying the representations of the plurality of media items (e.g., 620A-620H), detecting, via the one or more input devices, one or more user inputs (e.g., 624A and/or 624B) (e.g., one or more tap inputs and/or one or more non-tap inputs) corresponding to selection of one or more representations (e.g., 620A, 620B) of the plurality of media items, including a first representation representative of a first media item. In some embodiments, detecting the one or more user inputs corresponding to selection of one or more media items includes: while displaying the representations of the plurality of media items, detecting, via the one or more input devices, one or more user inputs corresponding to selection of a second representation (e.g., different from the first representation) representative of a second media item (e.g., different from the first media item). Displaying representations of a plurality of media items that are selectable by a user to identify media items to be transmitted enables a user to quickly select media items for transmission, thereby reducing the number of inputs needed to select media items for transmission. Reducing the number of inputs needed to perform an operation enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, in response to detecting the one or more user inputs corresponding to selection of the one or more media items, the computer system (e.g., 600) displays, via the display generation component, representations of the selected one or more media items in a manner indicative of the one or more media items being selected for transmission to an external computer system (e.g., 625A and/or 625B displayed in draft message field 610 in FIG. 6C; or 620A and/or 620B shown with check mark in bottom right corner). In some embodiments, displaying representations of the selected one or more media items in a manner indicative of the one or more media items being selected for transmission to an external computer system includes displaying representations of the selected one or more media items in a messaging user interface. In some embodiments, displaying representations of the selected one or more media items in a manner indicative of the one or more media items being selected for transmission to an external computer system includes displaying representations of the selected one or more media items in a draft message entry portion of the messaging user interface (e.g., a portion of the messaging user interface that displays a message being drafted for transmission into a message and/or communication session). Displaying representations of the selected one or more media items in a manner indicative of the one or more media items being selected for transmission to the external computer system provides the user with feedback about the current state of the device (e.g., that the device has recognized the one or more user inputs selecting the one or more media items for transmission to the external computer system). Providing improved feedback to the user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, displaying the visual indication that the one or more media items satisfy the set of sensitive content criteria includes: displaying a fourth selectable object (e.g., 634D, 640B) that is selectable to cancel transmission of media items that satisfy the set of sensitive content criteria. In some embodiments, the selected one or more media items includes: a first media item that satisfies the set of sensitive content criteria (e.g., content item 2) (e.g., a first media item that has been identified as potentially depicting and/or containing sensitive content); and a second media item that does not satisfy the set of sensitive content criteria (e.g., content item 1) (e.g., a second media item different from the first media item, and has not been identified as potentially depicting and/or containing sensitive content). In some embodiments, displaying representations of the selected one or more media items in a manner indicative of the one or more media items being selected for transmission to an external computer system includes: displaying, via the display generation component, a first representation of the first media item (e.g., 625B in FIG. 6C) in the manner indicative of the first media item being selected for transmission to the external computer system; and displaying (e.g., concurrently with the first representation of the first media item), via the display generation component, a second representation of the second media item (e.g., 625A in FIG. 6C) in the manner indicative of the second media item being selected for transmission to the external computer system. In some embodiments, while displaying the fourth selectable object (e.g., 634D or 640B), the computer system detects, via the one or more input devices, one or more user inputs (e.g., 636B) (e.g., one or more tap inputs and/or one or more non-tap inputs) corresponding to selection of the fourth selectable object (e.g., 634D). In response to detecting the one or more user inputs corresponding to selection of the fourth selectable object: the computer system (e.g., 600) ceases to display the first representation of the first media item in the manner indicative of the first media item being selected for transmission to the external computer system (e.g., ceases to display object 625B in draft message field 610 in FIG. 6F) (e.g., removes the first representation of the first media item from a draft message entry portion of a messaging user interface); and continues to display the second representation of the second media item in the manner indicative of the second media item being selected for transmission to the external computer system (e.g., continues to display object 625A in draft message field 610 in FIG. 6F) (e.g., continues to display the second representation of the second media item in the draft message entry portion of the messaging user interface). Ceasing to display the first representation of the first media item in the manner indicative of the first media item being selected for transmission to the external computer system while continuing to display the second representation of the second media item in the manner indicative of the second media item being selected for transmission to the external computer system provides the user with feedback about the current state of the device (e.g., that the device has removed the first media item from the set of media items that are selected for transmission to the external computer system). Providing improved feedback to the user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, subsequent to detecting the one or more user inputs (e.g., 636B) corresponding to selection of the fourth selectable object (e.g., 634D), and subsequent to ceasing to display the first representation of the media item (e.g., 625BA) in the manner indicative of the first media item being selected for transmission to the external computer system (e.g., FIG. 6F), and while continuing to display the second representation of the second media item (e.g., 625A) in the manner indicative of the second media item being selected for transmission to the external computer system (e.g., 625A in FIG. 6F), the computer system detects, via the one or more input devices, one or more user inputs (e.g., one or more tap inputs and/or one or more non-tap inputs) corresponding to a request to transmit content to the external computer system (e.g., a user input selecting send option 626 in FIG. 6F). In response to detecting the one or more user inputs corresponding to the request to transmit content to the external computer system, the computer system transmits the second media item (e.g., 625A in FIG. 6F) to the external computer system without displaying the visual indication that one or more media items satisfy the set of sensitive content criteria. In some embodiments, the computer system transmits the second media item to the external computer system without transmitting the first media item to the external computer system. Transmitting the second media item to the external computer system without displaying the visual indication that one or more media items satisfy the set of sensitive content criteria provides the user with feedback about the current state of the device (e.g., that the device has determined that the second media item does not satisfy the set of sensitive content criteria). Providing improved feedback to the user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

Note that details of the processes described above with respect to method 700 (e.g., FIG. 7) are also applicable in an analogous manner to the methods described below. For example, methods 900 and 1100 optionally include one or more of the characteristics of the various methods described above with reference to method 700. For example, sensitive content transmitted by a computer system in method 700 and/or received by a computer system in method 900 can be reported to the computer system in method 1100. For brevity, these details are not repeated below.

FIGS. 8A-8L illustrate exemplary user interfaces for managing receipt of content, in accordance with some embodiments. The user interfaces in these figures are used to illustrate the processes described below, including the processes in FIG. 9.

FIG. 8A depicts electronic device 600 described above. In FIG. 8A, electronic device 600 displays locked user interface 800, which includes notification 802 indicating that electronic device 600 has received a photo message from an external device. At FIG. 8A, electronic device 600 detects user input 804 corresponding to selection of notification 802.

At FIG. 8B, in response to user input 804, electronic device 600 depicts messaging user interface 604, which was discussed above with reference to FIGS. 6A-6L. As discussed above, in the depicted scenario, messaging user interface 604 corresponds to a communication session between electronic device 600 and an external device associated with phone number (234) 567-8910. In FIG. 8B, electronic device 600 has received two content items (e.g., two media items (e.g., photos and/or videos)) from the external device, content item 3 and content item 4. Object 806A, representative of content item 4, and object 806B, representative of content item 3, are displayed within message field 608. As discussed above with reference to FIGS. 6A-6L, in some embodiments, when content items are transmitted into the communication session, a determination is made as to whether the content items satisfy a set of sensitive content criteria (e.g., whether the content items may depict sensitive content). In FIG. 8B, a determination has been made that content item 4 does not satisfy the set of sensitive content criteria (e.g., does not depict sensitive content), but content item 3 does satisfy the set of sensitive content criteria (e.g., may depict sensitive content). Accordingly, content item 3 is displayed with indications 808A and 808B indicating that content item 3 satisfies the set of sensitive content criteria. Furthermore, in some embodiments, in accordance with a determination that content item 4 does not satisfy the set of sensitive content criteria, object 806A displays content item 4 (e.g., a preview and/or a thumbnail of content item 4), and in accordance with a determination that content item 3 does satisfy the set of sensitive content criteria, object 806B does not display content item 3. For example, in some embodiments, object 806B is blurred, or a solid color. Messaging user interface 604 includes object 810 that is selectable to initiate a process for viewing content item 4. In some embodiments, including the depicted embodiment, selection of object 806B also initiates a process for viewing content item 4. Messaging user interface 604 also includes object 811 that is selectable to initiate a process for transmitting one or more content items that are determined to satisfy the set of sensitive content criteria (e.g., content item 3) to a trusted contact (e.g., a parent, a guardian, and/or other trusted adult). In some embodiments, the trusted contact is a predetermined contact (e.g., a pre-specified phone number or email address).

FIG. 8C depicts an alternative embodiment of FIG. 8B, in which, rather than displaying content items 3 and 4 separately as in FIG. 8B, content items 3 and 4 (and any other content items that were transmitted as part of a single transmission) are jointly represented by object 808C. In the embodiment depicted in FIG. 8C, when there are some content items that do not satisfy the set of sensitive content criteria, none of the content items in the transmission can be seen within messaging user interface 604 based on a determination that at least one content item of the transmission satisfies the set of sensitive content criteria. Object 808C is displayed with indications 808A-1 and 808B-1 indicating that at least one content item of the set satisfies the set of sensitive content criteria.

In FIGS. 8B and 8C, electronic device 600 detects user input 813 corresponding to selection of object 811.

At FIG. 8C-1, in response to user input 813, electronic device 600 displays messaging user interface 604-2. In some embodiments, messaging user interface 604-2 is displayed in place of messaging user interface 604. In some embodiments, messaging user interface 604-2 is overlaid on top of messaging user interface 604. As discussed above, messaging user interface 604 in FIGS. 8B and 8C corresponds to a communication session between electronic device 600 and an external device associated with phone number 234-567-8910. In FIG. 8C-1, messaging user interface 604-2 corresponds to a second communication session between electronic device 600 and a second external device associated with phone number 987-654-3210. In some embodiments, phone number 987-654-3210 is the phone number of a trusted contact that has been identified (e.g., pre-specified) by a user of electronic device 600. Messaging user interface 604-1 includes participant information 606-2 that corresponds to the trusted contact and message field 608-2 that displays messages that have been transmitted into the second communication session (e.g., messages that have been transmitted between electronic device 600 and the second electronic device associated with the trusted contact). Messaging user interface 604-2 also includes option 815 that is selectable to return to messaging user interface 604 of FIG. 8C. Messaging user interface 604-2 also includes draft message field 610 that displays a draft message being drafted on electronic device 600 but has not yet been transmitted into the second communication session.

In FIG. 8C-1, in response to user input 813 corresponding to selection of option 811, draft message field 610 is pre-populated with a message to the trusted contact. The pre-populated message in FIG. 8C-1 includes object 817, which is representative of contact item 3 that has been identified as satisfying the set of sensitive content criteria. In some embodiments, object 817 does not display a preview (e.g., a thumbnail) of content item 3, as content item 3 has been determined to potentially depict sensitive content, and has not yet been viewed by the user of electronic device 600. The pre-populated message also includes a text message informing the trusted contact that content item 3 was received at electronic device 600, and requesting that the trusted contact view content item 3 to ensure that it is safe for the user of electronic device 600 to view.

Messaging user interface 604-2 includes send option 821 that is selectable to transmit the message in draft message field 610 into the second communication session (e.g., to the second external device associated with phone number 987-654-3210). In some embodiments, the user of electronic device 600 can modify the pre-populated message (e.g., via keyboard 614), or send the pre-populated message without modification (e.g., by selecting send option 821).

At FIG. 8C-1, while the pre-populated message is displayed in draft message field 610, electronic device 600 detects user input 823 corresponding to selection of send option 821.

At FIG. 8C-2, in response to user input 823, electronic device 600 transmits the pre-populated message into the second communication session, and displays object 825A (representative of content item 3) and message 825B in message field 608-2, indicating that content item 3 and message 825B have been transmitted to the second external device. As such, the trusted contact can now view content item 3 (e.g., on the second external device) and can inform the user of electronic device 600 whether or not content item 3 depicts appropriate content.

Returning to FIG. 8B, electronic device 600 detects user input 812 corresponding to selection of object 806B.

At FIG. 8D, in response to user input 812, electronic device 600 displays user interface 814. User interface 814 includes notification 818, which informs the user that content item 3 has been determined to potentially depict sensitive content. Notification 818 also informs the user that if the user chooses to view content item 3, a notification will be send to an external device (e.g., a device associated with the user's parents) indicating that the user chose to view content that has been identified as potentially depicting sensitive content. As will be discussed in greater detail below with reference to FIGS. 10A-10O, in some embodiments, if a user chooses to transmit and/or view content that has been determined to potentially depict sensitive content, information about the content is transmitted to another electronic device. In some embodiments, if a user receives (e.g., via electronic device 600) content that is identified as depicting sensitive content, but does not choose to view that content, information about the content is not transmitted to another electronic device. User interface 814 also includes option 816A, that is selectable to cancel the process for viewing content item 3 and return to messaging user interface 604 of FIG. 8B; option 816B that is selectable to opt not to view content item 3 and return to messaging user interface 604; and option 816C that is selectable to proceed with viewing content item 3. At FIG. 8D, electronic device 600 detects user input 820A, corresponding to selection of option 816B, and user input 820B, corresponding to selection of option 816C. Each of these user inputs will be discussed below.

At FIG. 8E, in response to detecting user input 820A corresponding to selection of option 816B in FIG. 8D, electronic device 600 displays messaging user interface 604. In FIG. 8E, object 806B, representative of content item 3, continues to forgo displaying content item 3 (e.g., messaging user interface 604 does not depict content item 3). Furthermore, in response to user input 820A, electronic device 600 displays option 822 that is selectable to initiate a process for blocking the sender of content item 3. In some embodiments, blocking another user includes ignoring and/or rejecting future messages received from the sender (e.g., forgoing displaying future messages from the sender and/or forgoing displaying notifications pertaining to future messages from sender).

FIG. 8F depicts an alternative embodiment of FIG. 8E, in which, in response to user input 820A in FIG. 8D, messaging user interface 604 no longer displays object 806B representative of content item 3. Accordingly, in the embodiment depicted in FIG. 8F, the user no longer has the option to view content item 3 at a later time, as content item 3 has been deleted (e.g., deleted from electronic device 600 and/or deleted from the communication session), and its representative object 806B has been removed from message field 608.

Returning to FIG. 8E, electronic device 600 detects user input 824 corresponding to selection of option 822.

At FIG. 8G, in response to detecting user input 824, electronic device 600 displays options 828A, 828B, 828C, and 828D. Option 828A is selectable to block a sender of content item 3. Option 828B is selectable to block a sender of content item 3, and report the sender of content item 3 for sending spam messages. Option 828C is selectable to block the sender of content item 3, and to report the sender of content item 3 for sending inappropriate and/or sensitive content. Option 828D is selectable to cancel the process for blocking the sender of content item 3, and return to messaging user interface 604 of FIG. 8E.

FIG. 8H depicts a scenario in which messaging user interface 604 corresponds to a communication session that includes electronic device 600 and a plurality of external devices (e.g., a group chat communication session). In the scenario shown in FIG. 8H, selection of block contact option 822 (e.g., user input 824) results in display of a slightly different set of options 832A-832D. Option 832A is selectable to leave the group chat communication session. In some embodiments, leaving a group chat communication session includes no longer receiving messages and/or receiving notifications of messages transmitted by external devices into the group chat communication session, as well as forgoing the ability to transmit messages into the group chat communication session. Option 832B is selectable to leave the group chat session, and report a sender of content item 3 for sending spam messages. Option 832C is selectable to leave the group chat session, and report a sender of content item 3 for sending inappropriate and/or sensitive content. Option 832D is selectable to cancel the process for blocking the sender of content item 3, and return to messaging user interface 604.

At FIG. 8I, in response to detecting user input 820B corresponding to selection of option 816C in FIG. 8D, electronic device 600 displays messaging user interface 604 in which object 806B displays content item 3 (e.g., displays a preview and/or a thumbnail of content item 3). Additionally, as mentioned above and as will be described in greater detail below with reference to FIGS. 10A-10O, in response to user input 820B (and in response to the user opting to view content item 3), information about content item 3, user input 820B, and the communication session is transmitted to an external device, and at least some of the same information is stored on electronic device 600. This information can, for example, be viewed at a later time by another user (e.g., a parent of the user). Furthermore, in response to user input 820B, messaging user interface 604 displays block contact option 822, and option 834. Option 834, similar to 646 of FIG. 6I, is selectable to initiate a process for the user to provide input as to whether content item 3 does actually depict sensitive content. In some embodiments, a user of electronic device 600 cannot save, copy, and/or share content item 3 until electronic device 600 displays content item 3 (e.g., until the user opts to view content item, and electronic device 600 displays content item 3). At FIG. 8I, electronic device 600 detects user input 836 corresponding to selection of option 834.

At FIG. 8J, in response to user input 836, electronic device 600 displays options 838A, 838B, and 838C. Option 838A is selectable to indicate that content item 3 does not depict sensitive content. Option 838B is selectable to indicate that content item 3 does, in fact, depict sensitive content. Option 838C is selectable to return to messaging user interface 604 of FIG. 8I without providing input as to whether content item 3 depicts sensitive content. At FIG. 8J, electronic device 600 detects user input 840 corresponding to selection of option 838A.

At FIG. 8K, in response to user input 840, electronic device 600 displays authentication user interface 842. At FIG. 8K, electronic device 600 detects one or more user inputs 846 entering authentication information via keypad 844. At FIG. 8L, in accordance with a determination that the authentication information received in FIG. 8K is valid (e.g., matches a stored passcode), electronic device 600 updates messaging user interface 604 to remove all indications (e.g., 808B) indicating that content item 3 depicts sensitive content (e.g., satisfies a set of sensitive content criteria). As discussed above, in some embodiments, user input 840 is also user to train and/or update a machine learning model based on the feedback that content item 3 does not depict sensitive content.

FIG. 9 is a flow diagram illustrating a method for managing receipt of content using a computer system in accordance with some embodiments. Method 900 is performed at a computer system (e.g., 100, 300, 500, or 600) (e.g., a smart phone, a smart watch, and/or a tablet) that is in communication with a display generation component (e.g., a display controller; a touch-sensitive display system; and/or a display (e.g., integrated and/or connected)) and one or more input devices (e.g., a touch-sensitive surface (e.g., a touch-sensitive display); a mouse; a keyboard; and/or a remote control). Some operations in method 900 are, optionally, combined, the orders of some operations are, optionally, changed, and some operations are, optionally, omitted.

As described below, method 900 provides an intuitive way for managing receipt of content. The method reduces the cognitive burden on a user for managing receipt of content, thereby creating a more efficient human-machine interface. For battery-operated computing devices, enabling a user to manage receipt of content faster and more efficiently conserves power and increases the time between battery charges.

The computer system displays (902), via the display generation component, a communication session user interface (e.g., 604) corresponding to a communication session (e.g., audio, video, and/or text-based communication session) involving the computer system (e.g., 600) and one or more external computer systems, including a first external computer system (e.g., “(234) 567-8910” in FIG. 8B).

The computer system receives (904) visual content information (e.g., 806A and/or 806B) corresponding to visual content transmitted into the communication session by the first external computer system (e.g., image content and/or video content).

In response to receiving the visual content information corresponding to visual content transmitted into the communication session by the first external computer system (906): and in accordance with a determination that the visual content satisfies a set of sensitive content criteria (908) (e.g., in accordance with a determination that the visual content potentially contains sensitive content (e.g., inappropriate content, graphic content, and/or illegal content)) (e.g., based on one or more machine learning models), the computer system displays (910) (e.g., within the communication session user interface), via the display generation component, a visual indication (e.g., 808A and/or 808B) that the received visual content (e.g., 806B) has been identified as potentially containing sensitive content without displaying the visual content. In some embodiments, in accordance with a determination that the visual content does not satisfy the set of sensitive content criteria (e.g., in accordance with a determination that the visual content does not contain sensitive content) (e.g., based on one or more machine learning models), the computer system displays, via the display generation component, the visual content (e.g., within the communication session user interface) (e.g., without displaying the visual indication that the received visual content has been identified as potentially containing sensitive content). Displaying the visual indication that the received visual content has been identified as potentially containing sensitive content in accordance with a determination that the visual content satisfies the set of sensitive content criteria provides the user with feedback about the current state of the device (e.g., that the device has determined that the visual content satisfies the set of sensitive content criteria). Providing improved feedback to the user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently. The device also provides enhanced usability to a user by obfuscating receive content that is potentially sensitive without the user having to take any additional action. This proactive step also makes the device more efficient since the user does not have to take additional steps to hide or block sensitive content.

In some embodiments, the visual indication that the received visual content has been identified as potentially containing sensitive content includes a textual indication (e.g., 808B) that the visual content has been identified as potentially containing sensitive content. Displaying a textual indication that the received visual content has been identified as potentially containing sensitive content in accordance with a determination that the visual content satisfies the set of sensitive content criteria provides the user with feedback about the current state of the device (e.g., that the device has determined that the visual content satisfies the set of sensitive content criteria). Providing improved feedback to the user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, displaying the visual indication that the received visual content has been identified as potentially containing sensitive content without displaying the visual content includes displaying a representation of the visual content (e.g., 806B) (e.g., a blurred and/or obscured representation (e.g., a tile and/or shape)) without displaying the visual content. Displaying a representation of the visual content without displaying the visual content provides improved security by preventing unauthorized display of sensitive content. Providing improved security enhances the operability of the device and makes the user-device interface more efficient and/or secure (e.g., by restricting unauthorized access) which, additionally, reduces power usage and improves battery life of the device by limiting the performance of restricted operations.

In some embodiments, in accordance with the determination that the visual content satisfies the set of sensitive content criteria, the computer system displays (e.g., concurrently with the visual indication that the received visual content has been identified as potentially containing sensitive content and/or subsequent to displaying the visual indication that the received visual content has been identified as potentially containing sensitive content), via the display generation component, a first selectable object (e.g., 806B and/or 810) that is selectable to initiate a process for displaying the visual content. Displaying a selectable option that allows a user to selectively display the visual content provides improved security by preventing unauthorized display of sensitive content and allowing a user to choose which content is displayed. Providing improved security enhances the operability of the device and makes the user-device interface more efficient and/or secure (e.g., by restricting unauthorized access) which, additionally, reduces power usage and improves battery life of the device by limiting the performance of restricted operations.

In some embodiments, subsequent to displaying (e.g., while displaying) the first selectable object, the computer system detects, via the one or more input devices, one or more user inputs (e.g., 812 and/or 820B) (e.g., one or more tap inputs and/or one or more non-tap inputs) corresponding to a user request to display the visual content, wherein the one or more user inputs corresponding to the user request to display the visual content includes one or more user inputs (e.g., 812) corresponding to selection of the first selectable object (e.g., 806B). In response to detecting the one or more user inputs (e.g., 812 or 820B) corresponding to the user request to display the visual content, the computer system displays, via the display generation component, the visual content (e.g., 806B in FIG. 8I). Displaying a selectable option that allows a user to selectively display the visual content provides improved security by preventing unauthorized display of sensitive content and allowing a user to choose which content is displayed. Providing improved security enhances the operability of the device and makes the user-device interface more efficient and/or secure (e.g., by restricting unauthorized access) which, additionally, reduces power usage and improves battery life of the device by limiting the performance of restricted operations.

In some embodiments, in response to detecting the one or more user inputs corresponding to the user request to display the visual content (e.g., 812 or 820B), the computer system displays (e.g., concurrently with the visual content) a first option (e.g., 834) that is selectable to initiate a process to indicate that the visual content does not depict sensitive content. In some embodiments, one or more user inputs indicating that the visual content does not depict sensitive content are used to train and/or update a machine learning model. In some embodiments, the computer system, while displaying the first option, detects, via the one or more input devices, one or more user inputs (e.g., one or more tap inputs and/or one or more non-tap inputs) corresponding to selection of the first option; in response to detecting the one or more user inputs corresponding to selection of the first option, the computer system displays, via the display generation component, a selectable object that is selectable to indicate that the visual content does not depict sensitive content (and, optionally, concurrently displays a selectable object that is selectable to indicate that the visual content does depict sensitive content); while displaying the selectable object, the computer system detects, via the one or more input devices, one or more user inputs (e.g., one or more tap inputs and/or one or more non-tap inputs) corresponding to selection of the selectable object; and in response to detecting the one or more user inputs corresponding to selection of the selectable object, the computer system ceases to display an indication that the visual content may depict sensitive content. Providing users with the ability to indicate that the visual content does not depict sensitive content improves security by providing means for improving on the set of sensitive content criteria (e.g., improving a machine learning model that identifies sensitive content). Providing improved security enhances the operability of the device and makes the user-device interface more efficient and/or secure (e.g., by restricting unauthorized access) which, additionally, reduces power usage and improves battery life of the device by limiting the performance of restricted operations.

In some embodiments, while displaying the first option (e.g., 834), the computer system detects, via the one or more input devices, one or more user inputs (e.g., 836) (e.g., one or more tap inputs and/or one or more non-tap inputs) corresponding to selection of the first option. Subsequent to detecting the one or more user inputs (e.g., 836) corresponding to selection of the first option (e.g., in response to detecting the one or more user inputs corresponding to selection of the first option), the computer system displays, via the display generation component, an authentication user interface (e.g., 842) that prompts a user for authentication information (e.g., a password entry user interface requesting entry of a user password and/or a PIN entry user interface requesting entry of a user PIN). In some embodiments, displaying the authentication user interface subsequent to detecting the one or more user inputs corresponding to selection of the first option includes: in response to detecting the one or more user inputs corresponding to selection of the first option, displaying, via the display generation component, a selectable object that is selectable to indicate that the one or more media items do not contain and/or depict sensitive content; while displaying the selectable object, detecting, via the one or more input devices, one or more user inputs (e.g., one or more tap inputs and/or one or more non-tap inputs) corresponding to selection of the selectable object; and in response to detecting the one or more user inputs corresponding to selection of the selectable object, displaying the authentication user interface. In some embodiments, while displaying the authentication user interface, the computer system receives, via the one or more input devices, authentication information; in response to receiving the authentication information: in accordance with a determination that the authentication information satisfies a set of authentication criteria (e.g., an entered PIN matches a stored PIN and/or an entered password matches a stored password), the computer system ceases to display the visual indication that the visual content has been identified as potentially containing sensitive content. Displaying an authentication user interface requesting authentication information subsequent to (e.g., in response to) detecting one or more user inputs corresponding to selection of the first option provides security and can prevent unauthorized users from initiating sensitive operations. Providing improved security enhances the operability of the device and makes the user-device interface more efficient and/or secure (e.g., by restricting unauthorized access) which, additionally, reduces power usage and improves battery life of the device by limiting the performance of restricted operations.

In some embodiments, the one or more user inputs corresponding to the user request to display the visual content (e.g., 812, 820B) cause a second external computer system (e.g., 1000) (e.g., a second external computer system different from the first external computer system) to receive a notification (e.g., 1090) (and, optionally, display a notification) indicating that the computer system (e.g., 600) has received and displayed visual content potentially containing sensitive content (e.g., 806B, content item 3). In some embodiments, the second external computer system is a computer system that has been identified as belonging to and/or corresponding to a parent and/or guardian of a user of the computer system. Causing a second external computer system to receive a notification pertaining to visual content received at and displayed by the computer system provides security and can notify users of unauthorized and/or undesirable display of sensitive content. Providing improved security enhances the operability of the device and makes the user-device interface more efficient and/or secure (e.g., by restricting unauthorized access) which, additionally, reduces power usage and improves battery life of the device by limiting the performance of restricted operations.

In some embodiments, the one or more user inputs corresponding to the user request to display the visual content (e.g., 812 or 820B) cause a third external computer system (e.g., 1000) (e.g., the second external computer system) (e.g., a third external computer system different from the external computer system) to receive information pertaining to the received visual content (e.g., user interface 1068, information 1072A-1072D, user interface 1078, and/or information 1080B-1080F) (e.g., one or more senders of the content (e.g., names, phone numbers, email addresses, and/or usernames), one or more other recipients of the visual content (e.g., names, phone numbers, email addresses, and/or usernames), a copy of the content, and/or date/time content was received and/or viewed). In some embodiments, information pertaining to the received visual content is not received at the third external computer system (e.g., is not transmitted to the third external computer system) if a user of the computer system does not opt to view the received visual content (e.g., does not provide one or more user inputs corresponding to a request to display the visual content). In some embodiments, the computer system stores (e.g., locally on the computer system) the information pertaining to the received visual content that is received at the third external computer system. In some embodiments, the information pertaining to the visual content received at the third external computer system does not include a copy of the visual content. In some embodiments, the computer system stores a copy of the visual content. In some embodiments, the information pertaining to the received visual content is displayed on the third external computer system (e.g., in response to one or more user inputs received at the third external computer system). In some embodiments, the information pertaining to the received visual content can be displayed at the computer system (e.g., in response to one or more user inputs received at the computer system). In some embodiments, the third external computer system is a computer system that has been identified as belonging to and/or corresponding to a parent and/or guardian of a user of the computer system. Causing a third external computer system to receive information pertaining to visual content received at and displayed by the computer system provides security and can notify users of unauthorized and/or undesirable display of sensitive content. Providing improved security enhances the operability of the device and makes the user-device interface more efficient and/or secure (e.g., by restricting unauthorized access) which, additionally, reduces power usage and improves battery life of the device by limiting the performance of restricted operations.

In some embodiments, in accordance with the determination that the visual content satisfies the set of sensitive content criteria, the computer system displays (e.g., concurrently with the first selectable object), via the display generation component, a second selectable object (e.g., 816B) that is selectable to forgo displaying the visual content. In some embodiments, while displaying the second selectable object, the computer system detects, via the one or more input devices, one or more user inputs (e.g., one or more tap inputs and/or one or more non-tap inputs) corresponding to selection of the second selectable object; and, in response to detecting the one or more user inputs corresponding to selection of the second selectable object, the computer system continues to display the visual indication that the received content has been identified as potentially containing sensitive content without displaying the visual content. Displaying a selectable option that allows a user to selectively display or not display the visual content provides improved security by preventing unauthorized display of sensitive content and allowing a user to choose which content is displayed. Providing improved security enhances the operability of the device and makes the user-device interface more efficient and/or secure (e.g., by restricting unauthorized access) which, additionally, reduces power usage and improves battery life of the device by limiting the performance of restricted operations.

In some embodiments, displaying the visual indication that the received visual content has been identified as potentially containing sensitive content without displaying the visual content includes displaying a representation of the visual content (e.g., 808B in FIG. 8B) (e.g., a blurred and/or obscured representation (e.g., a tile and/or shape)) (e.g., within a communication session user interface). In some embodiments, while displaying the second selectable object (e.g., 816B), the computer system detects, via the one or more input devices, one or more user inputs (e.g., one or more tap inputs and/or one or more non-tap inputs) corresponding to selection of the second selectable object (e.g., 820A). In response to detecting the one or more user inputs corresponding to selection of the second selectable object, the computer system ceases to display the representation of the visual content (e.g., FIG. 8F) (e.g., within the communication session user interface). Ceasing to display the representation of the visual content in response to the one or more user inputs corresponding to selection of the second selectable object provides the user with feedback about the current state of the device (e.g., that the device has detected the one or more user inputs corresponding to selection of the second selectable object). Providing improved feedback to the user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, the visual content includes a first media item (e.g., 806A) and a second media item different from the first media item (e.g., 806B). In response to receiving the visual content information corresponding to visual content transmitted into the communication session by the first external computer system: in accordance with a determination that the first media item (e.g., 806B, content item 3) satisfies the set of sensitive content criteria (e.g., in accordance with a determination that the first media item potentially contains sensitive content), and that the second media item (e.g., 806A, content item 4) does not satisfy the set of sensitive content criteria (e.g., in accordance with a determination that the second media item does not contain sensitive content): the computer system displays, via the display generation component, the second media item (e.g., 806A in FIG. 8B); and displays (e.g., concurrently with the second media item), via the display generation component, a visual indication (e.g., 808B) that the first media item has been identified as potentially containing sensitive content without displaying the first media item. In some embodiments, in accordance with a determination that the second media item satisfies the set of sensitive content criteria and that the first media item does not satisfy the set of sensitive content criteria, the computer system displays the first media item, and displays (e.g., concurrently with the first media item), a visual indication that the second media item has been identified as potentially containing sensitive content without displaying the second media item. In some embodiments, in accordance with a determination that the first media item and the second media item satisfy the set of sensitive content criteria, the computer system displays a visual indication that the first media item has been identified as potentially containing sensitive content without displaying the first content item, and the computer system display a visual indication that the second media item has been identified as potentially containing sensitive content without displaying the second content item. In some embodiments, in accordance with a determination that the first media item and the second media does not satisfy the set of sensitive content criteria, the computer system displays (e.g., concurrently displays) the first media item and the second media item. Displaying the second media item without displaying the first media item provides the user with feedback about the current state of the device (e.g., that the device has determined that the first media item satisfies the set of sensitive content criteria, and the second media item does not satisfy the set of sensitive content criteria). Providing improved feedback to the user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, the visual content includes a plurality of media items including a first media item (e.g., 806B) and a second media item (e.g., 806A) different from the first media item. In response to receiving the visual content information corresponding to visual content transmitted into the communication session by the first external computer system, and in accordance with a determination that the first media item (e.g., 806B, content item 3) satisfies the set of sensitive content criteria (e.g., in accordance with a determination that the first media item potentially contains sensitive content), and that the second media item (e.g., 806A, content item 4) does not satisfy the set of sensitive content criteria (e.g., in accordance with a determination that the second media item does not contain sensitive content): the computer system displays, via the display generation component, a visual indication (e.g., 808A-1 or 808B-1) that one or more media items of the visual content has been identified as potentially containing sensitive content without displaying the first media item and without displaying the second media item (e.g., FIG. 8C) (e.g., without displaying any of the plurality of media items). Displaying the visual indication that one or more media items of the visual content has been identified as potentially containing sensitive content without displaying the media items provides the user with feedback about the current state of the device (e.g., that the device has determined that one or more media items of the visual content satisfy the set of sensitive content criteria). Providing improved feedback to the user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, subsequent to receiving the visual content information corresponding to visual content transmitted into the communication session by the first external computer system, and in accordance with the determination that the visual content satisfies the set of sensitive content criteria (or, optionally, in response to receiving one or more user inputs corresponding to selection of an option to forgo displaying the visual content), the computer system displays, via the display generation component, a third selectable object (e.g., 822) that is selectable to initiate a process for reporting a sender of the visual content (e.g., a user of the first external computer system) (e.g., reporting the sender of the visual content to a third party) (e.g., transmitting user information (e.g., email address, phone number, and/or name) of the sender of the visual content to a third party). Displaying the third selectable object that is selectable to initiate a process for reporting the sender of the visual content enables a user to quickly report the sender of the visual content, thereby reducing the number of inputs needed to report the sender of the visual content. Reducing the number of inputs needed to perform an operation enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, subsequent to receiving the visual content information corresponding to visual content transmitted into the communication session by the first external computer system, and in accordance with the determination that the visual content satisfies the set of sensitive content criteria (or, optionally, in response to receiving one or more user inputs corresponding to selection of an option to forgo displaying the visual content), the computer system displays, via the display generation component, a fourth selectable object (e.g., 822, 828A, 830, 832A, 832B, or 832C) that is selectable to initiate a process for leaving the communication session (e.g., removing the computer system from the communication session). In some embodiments, while in the communication session, the computer system receives and/or displays notifications for messages transmitted into the communication session by one or more external computer systems, and after leaving the communication session, the computer system ceases to receive and/or display notifications for messages transmitted into the communication session. In some embodiments, while in the communication session, the computer system can access and/or display one or more messages transmitted into the communication session (e.g., by one or more external computer systems), and after leaving the communication session, the computer system can no longer access and/or display messages transmitted into the communication session. Displaying the fourth selectable object that is selectable to initiate a process for leaving the communication session enables a user to quickly leave the communication session, thereby reducing the number of inputs needed to leave the communication session. Reducing the number of inputs needed to perform an operation enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, subsequent to receiving the visual content information corresponding to visual content transmitted into the communication session by the first external computer system, and in accordance with the determination that the visual content satisfies the set of sensitive content criteria (or, optionally, in response to receiving one or more user inputs corresponding to selection of an option to forgo displaying the visual content), the computer system displays, via the display generation component, a fifth selectable object (e.g., 822) that is selectable to initiate a process for blocking a sender of the visual content (e.g., a user of the first external computer system) (e.g., blocking and/or refusing future communications from the first external computer system and/or from the user of the first external computer system). In some embodiments, if a sender is not blocked on the computer system, the computer system displays messages and notifications of messages transmitted from the sender to the computer system, and if the sender is blocked on the computer system, the computer system no longer displays messages and/or notifications of messages transmitted from the sender to the computer system. Displaying the fifth selectable object that is selectable to initiate a process for blocking the sender of the visual content enables a user to quickly block the sender of the visual content, thereby reducing the number of inputs needed to block the sender of the visual content. Reducing the number of inputs needed to perform an operation enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, the visual content cannot be saved to the computer system and/or shared by the computer system until the visual content is displayed on the computer system (e.g., via the display generation component). In some embodiments, the visual content cannot be saved to the computer system and/or shared by the computer system until the computer system receives one or more user inputs corresponding to a request to display the visual content. Prohibiting the computer system from saving and/or sharing the visual content until the visual content is displayed on the computer system provides security by preventing unauthorized visual content from being saved to and/or transmitted by the computer system. Providing improved security enhances the operability of the device and makes the user-device interface more efficient and/or secure (e.g., by restricting unauthorized operations) which, additionally, reduces power usage and improves battery life of the device by limiting the performance of restricted operations.

In some embodiments, in accordance with a determination that the visual content satisfies the set of sensitive content criteria, the computer system displays (e.g., concurrently with the visual indication that the received visual content has been identified as potentially containing sensitive content and/or subsequent to displaying the visual indication that the received visual content has been identified as potentially containing sensitive content), via the display generation component, a sixth selectable object (e.g., 811) that is selectable to initiate a process for transmitting a message into a second communication session different from the communication session (e.g., FIGS. 8C-1, 8C-2), wherein the second communication session involves the computer system and a fourth external computer system different from the first external computer system. In some embodiments, the second communication session does not involve the first external computer system. In some embodiments, the fourth external computer system is a computer system that has been identified as belonging to and/or corresponding to a parent, guardian, and/or trusted adult of a user of the computer system. In some embodiments, the sixth selectable object is selectable to display a user interface corresponding to the second communication session, including a prepopulated message notifying a user of the fourth external computer system of the visual content transmitted into the communication session by the first external computer system. In some embodiments, the prepopulated message, when transmitted into the second communication session, allows the user of the fourth external computer system to view the visual content transmitted into the communication session by the first external computer system. Allowing the user of the computer system to transmit a message to a fourth external computer system pertaining to visual content received at the computer system provides security and can notify users of unauthorized and/or undesirable display of sensitive content. Providing improved security enhances the operability of the device and makes the user-device interface more efficient and/or secure (e.g., by restricting unauthorized access) which, additionally, reduces power usage and improves battery life of the device by limiting the performance of restricted operations.

In some embodiments, subsequent to displaying (e.g., while displaying) the sixth selectable object, the computer system detects, via the one or more input devices, one or more user inputs (e.g., 813) (e.g., one or more tap inputs and/or one or more non-tap inputs) corresponding to selection of the sixth selectable object (e.g., 811). In response to detecting the one or more user inputs corresponding to selection of the sixth selectable object, the computer system displays, via the display generation component, a communication session user interface (e.g., 604-2) corresponding to the second communication session (e.g., replaces display of the communication session user interface corresponding to the communication session with the communication session user interface corresponding to the second communication session and/or overlays the communication session user interface corresponding to the second communication session over the communication session user interface corresponding to the communication session), including displaying, within the communication session user interface corresponding to the second communication session, a prepopulated message (e.g., field 610 in FIGS. 8C-1 and 8C-2) that notifies a user of the fourth external computer system of the visual content transmitted into the communication session by the first external computer system. In some embodiments, the prepopulated message, when transmitted into the second communication session, allows the user of the fourth external computer system to view the visual content transmitted into the communication session by the first external computer system. In some embodiments, displaying the communication session user interface corresponding to the second communication session includes displaying a seventh selectable object that is selectable to transmit the prepopulated message into the second communication session. In some embodiments, the prepopulated message is displayed within a message entry field in the user interface corresponding to the second communication session. In some embodiments, the prepopulated message is editable (e.g., can be edited by a user based on one or more user inputs). Allowing the user of the computer system to transmit a message to a fourth external computer system pertaining to visual content received at the computer system provides security and can notify users of unauthorized and/or undesirable display of sensitive content. Providing improved security enhances the operability of the device and makes the user-device interface more efficient and/or secure (e.g., by restricting unauthorized access) which, additionally, reduces power usage and improves battery life of the device by limiting the performance of restricted operations.

Note that details of the processes described above with respect to method 900 (e.g., FIG. 9) are also applicable in an analogous manner to the methods described below and/or above. For example, methods 700 and 1100 optionally include one or more of the characteristics of the various methods described above with reference to method 900. For example, sensitive content transmitted by a computer system in method 700 and/or received by a computer system in method 900 can be reported to the computer system in method 1100. For brevity, these details are not repeated below.

FIGS. 10A-10O illustrate exemplary user interfaces for managing receipt and/or transmission of content, in accordance with some embodiments. The user interfaces in these figures are used to illustrate the processes described below, including the processes in FIG. 11.

FIG. 10A depicts electronic device 600 described above. In FIG. 10A, electronic device 600 depicts user interface 1004, which includes option 1006A and option 1006B. Option 1006A is selectable to enable a setting that will cause electronic device 600 to check content items (e.g., media items (e.g., photos and/or videos)) that are transmitted from electronic device 600 and/or received by electronic device 600 to determine whether the content items satisfy a set of sensitive content criteria (e.g., whether the content items depict sensitive content). Option 1006B is selectable to disable this setting. At FIG. 10A, electronic device 600 detects user input 1008 corresponding to selection of option 1006A.

At FIG. 10B, in response to user input 1008, electronic device 600 displays user interface 1010, which includes options 1012A and 1012B. Option 1012A is selectable to enable a setting that will cause an external device (e.g., an external device corresponding to a parent of the user of electronic device 600) to receive a notification if a user of electronic device 600 transmits content that satisfies the set of sensitive content criteria or views content (e.g., views content received at electronic device 600 and transmitted by an external device) that satisfies the set of sensitive content criteria. Option 1012B is selectable to disable this setting. At FIG. 10B, electronic device 600 detects user input 1014 corresponding to selection of option 1012A.

At FIG. 10C, in response to user input 1014, electronic device 600 displays user interface 1010. User interface 1010 includes option 1016A and option 1016B. Option 1016A is selectable to define and/or create a passcode that is required to modify the settings that were enabled in FIGS. 10A and 10B. In some embodiments, the passcode is also required in order for a user to mark content items that were identified as potentially containing sensitive content as not depicting sensitive content (e.g., FIGS. 6K and 8K above). In some embodiments, the passcode is also required in order to access transmission instance records that contain information about instances in which a user used electronic device 600 to transmit sensitive content and/or receive and view sensitive content (e.g., FIGS. 10E and 10K below). Option 1016B is selectable to forgo creating a passcode. In FIG. 10C, electronic device 600 detects user input 1018 corresponding to selection of option 1016A.

At FIG. 10D, in response to user input 1018, electronic device displays passcode setting user interface 1020. At FIG. 10D, electronic device detects one or more user inputs 1014 via keypad 1022 to set a passcode.

At FIG. 10E, electronic device 600 displays communication safety user interface 1026. User interface 1026 includes option 1028A that can be enabled or disabled to enable or disable a setting for checking for transmission and/or receipt of sensitive content items (e.g., the setting that was enabled in FIG. 10A), and option 1028C that can be enabled or disabled to enable or disable a setting for sending notification to an external device if sensitive content items are sent and/or viewed on electronic device 600 (e.g., the setting that was enabled in FIG. 10B). User interface 1026 also includes option 1030 that is selectable to view a record of transmission instances in which sensitive content items (e.g., content items that satisfy the set of sensitive content criteria) were transmitted from electronic device 600 and/or received and viewed on electronic device 600. At FIG. 10E, electronic device 600 detects user input 1030 corresponding to selection of option 1028B.

At FIG. 10F, in response to user input 1030, electronic device 600 displays authentication user interface 1032. In order to access the log of sensitive content transmission instances, a user must enter a predefined passcode (e.g., the passcode that was set in FIG. 10D). In FIG. 10F, electronic device detects one or more user inputs 1036 corresponding to entry of a passcode via keypad 1034.

At FIG. 10G, in accordance with a determination that the passcode received via authentication user interface 1032 satisfies authentication criteria (e.g., in accordance with a determination that the passcode matches a stored passcode), electronic device 600 displays user interface 1038. User interface 1038 includes representations of a plurality of transmission instances 1040A, 1040B, 1040C, and 1040D in which electronic device 600 transmitted content that satisfied the set of sensitive content criteria and/or received and viewed content that satisfied the set of sensitive content criteria. At FIG. 10G, electronic device 600 detects user input 1042 corresponding to selection of representation 1040A, representative of a first transmission instance.

At FIG. 10H, in response to user input 1042, electronic device 600 displays transmission instance record user interface 1044, which corresponds to a first transmission instance in which electronic device 600 transmitted a photo that was determined to satisfy the set of sensitive content criteria. User interface 1044 includes back option 1046A that is selectable to return to user interface 1038. User interface 1044 also includes a record of information pertaining to the first transmission instance, including option 1046B that is selectable to view a copy of the photo, date information 1046C (e.g., the date on which the photo was sent to an external device), time information 1046D (e.g., the time at which the photo was sent to an external device), deletion indication 1046E which indicates that the transmitted photo was deleted from the message user interface and/or the message application, and contact information 1046F (e.g., a phone number, an email address, and/or user ID corresponding to one or more recipients of the transmitted photo). The transmission information shown in FIG. 10H can also be applied to transmission instances in which a user used electronic device 600 to receive and view sensitive content. For example, option 1046B can be selectable to view a copy of the viewed photo, date information 1046C and time information 1046D can indicate the date and time at which the photo was received and/or viewed, deletion indication 1046E can indicate whether the received photo was deleted, and contact information 1046F can include contact information (e.g., phone number, email address, and/or user ID) for a sender of the photo and/or one or more other recipients of the photo.

User interface 1044 also includes option 1046G that is selectable to view “context” surrounding the content item, such as one or more messages in the communication session that occurred before and/or after the content item (e.g., immediately before and/or immediately after); option 1046H that is selectable to delete the first transmission instance from user interface 1038 (e.g., delete the first transmission instance from a record of transmission instances in which sensitive content was transmitted by and/or received and viewed at electronic device 600); and option 1046I that is selectable to report a sender and/or a recipient of the photo (e.g., to a third party). At FIG. 10H, electronic device 600 detects user input 1048 corresponding to selection of option 1046G.

At FIG. 10I, in response to user input 1048, electronic device 600 displays user interface 1050, which provides “context” surrounding the transmitted sensitive content item. As can be seen in FIG. 10I, user interface 1050 displays one or more messages (e.g., 1051B) that were transmitted into the communication session (e.g., by electronic device 600 and/or one or more external devices) immediately before and/or immediately after the sensitive content item was transmitted into the communication session. In some embodiments, user interface 1050 displays the sensitive content item (e.g., representation 1051A). In some embodiments, user interface 1050 does not display the sensitive content item (e.g., representation 1051A is an obscured and/or blurred representation of the sensitive content item). User interface 1050 also includes option 1052 that is selectable to return to user interface 1044.

FIGS. 10A-10I illustrated example user interfaces and content that is accessible via the device that actually transmitted and/or received and viewed sensitive content (e.g., a “child's phone”). As discussed above, in some embodiments, when an electronic device transmits and/or views sensitive content, a notification and transmission information indicative of the transmitted and/or viewed sensitive content is sent to an external device (e.g., a “parent's device” or “parent's phone”). FIGS. 10J-10O illustrate user interfaces and content that are accessible from the external device (e.g., the “parent's phone).

FIG. 10J depicts electronic device 1000, which is a smartphone with touch-screen display 1002. In some embodiments, electronic device 1000 includes one or more features of devices 100, 300, and/or 500. Electronic device 1000 depicts communication safety user interface 1054. User interface 1054 includes option 1056A that can be enabled to enable checking for transmission and/or receipt (e.g., receipt and viewing) of sensitive content on another device (e.g., a child's device (e.g., device 600)). User interface 1054 also includes option 1056C that can be enabled to enable receiving notifications at electronic device 1000 if the other device (e.g., child's device (e.g., device 600)) transmits content that is determined to satisfy the set of sensitive content criteria and/or receives and views content that is determined to satisfy the set of sensitive content criteria. User interface 1054 also includes option 1058 that is selectable to view a record of transmission instances in which the other device (e.g., child's device (e.g., device 600)) transmitted and/or received and viewed content that is determined to satisfy the set of sensitive content criteria. At FIG. 10J, electronic device 1000 detects user input 1058 corresponding to selection of option 1056B.

At FIG. 10K, in response to user input 1058, electronic device 1000 displays authentication user interface 1060. In order to view the record of transmission instances, a user must enter a passcode (e.g., the passcode set in FIG. 10D). In FIG. 10K, electronic device 1000 detects one or more user inputs 1066 corresponding to entry of authentication information via keypad 1064.

At FIG. 10L, in accordance with a determination that the authentication information received in FIG. 10K satisfy authentication criteria (e.g., match a stored passcode), electronic device 1000 displays user interface 1068. User interface 1068 is substantially similar to user interface 1038 that was accessible on the child's device (e.g., device 600). User interface 1068 includes option 1070 that is selectable to return to user interface 1054. User interface 1068 also includes representations of a plurality of transmission instances 1072A, 1072B, 1072C, and 1072D. Each transmission instance corresponds to an instance in which electronic device 600 transmitted and/or received and viewed content that was determined to satisfy the set of sensitive content criteria. In FIG. 10L, electronic device 1000 detects user input 1074 corresponding to selection of representation 1072A, which is representative of a first transmission instance in which electronic device 600 transmitted a first content item to another device, and the first content item was determined to satisfy the set of sensitive content criteria.

At FIG. 10M, in response to user input 1074, electronic device 1000 displays transmission instance record user interface 1078, which is substantially similar to user interface 1044, with a few differences. In the depicted embodiment, user interface 1078 does not include and/or provide access to a copy of the first content item (whereas user interface 1044 did provide access to the transmitted content item). In some embodiments, the sensitive content item that was transmitted by and/or viewed on electronic device 600 is not provided to and/or transmitted to electronic device, for example, so that sensitive content items are not unnecessarily further transmitted to additional devices. Similar to user interface 1044, user interface 1078 includes date information 1080B, time information 1080C, deletion indication 1080D, and contact information 1080E. In the depicted embodiment, the contact information 1080D in user interface 1078 on electronic device 1000 has incomplete contact information (e.g., only the last four digits of a phone number, or a partial email address, or a partial user ID), whereas user interface 1044 on electronic device 600 has complete contact information. Similar to user interface 1044, user interface 1078 includes view conversation option 1080F, delete from summary option 1080G, and report option 1080H. At FIG. 10M, electronic device 1000 detects user input 1082 corresponding to selection of option 1080F.

At FIG. 10N, in response to user input 1082, electronic device 1000 displays user interface 1084, which displays one or more messages 1085B transmitted into a communication session before and/or after the first content item 1085A was transmitted into the communication session. In some embodiments, user interface 1084 displays a representation of the first content item 1085A without displaying the first content item, whereas user interface 1050 of FIG. 10I does display the first content item.

At FIG. 10O, electronic device 1000 displays a lock screen user interface 1088 indicating that electronic device 1000 is in a locked state, and also displays notification 1090. Notification 1090 indicates that an external device (e.g., an external device associated with a user named “Johnny”) is participating in a communication session in which the external device was used to transmit content that satisfies a set of sensitive content criteria, and/or the external device was used to receive and view content that satisfies the set of sensitive content criteria.

FIG. 11 is a flow diagram illustrating a method for managing receipt and/or transmission of content using a computer system in accordance with some embodiments. Method 1100 is performed at a computer system (e.g., 100, 300, 500, or 1000) (e.g., a smart phone, a smart watch, and/or a tablet) that is in communication with a display generation component (e.g., a display controller; a touch-sensitive display system; and/or a display (e.g., integrated and/or connected)) and one or more input devices (e.g., a touch-sensitive surface (e.g., a touch-sensitive display); a mouse; a keyboard; and/or a remote control). Some operations in method 1100 are, optionally, combined, the orders of some operations are, optionally, changed, and some operations are, optionally, omitted.

As described below, method 1100 provides an intuitive way for managing receipt and/or transmission of content. The method reduces the cognitive burden on a user for managing receipt and/or transmission of content, thereby creating a more efficient human-machine interface. For battery-operated computing devices, enabling a user to manage receipt and/or transmission of content faster and more efficiently conserves power and increases the time between battery charges.

The computer system (e.g., 1000) receives (1102) content transmission information (e.g., 1072A, 1072B, 1072C, 1072D, and/or 1080B-1080F)) associated with a first external computer system (e.g., 600) (e.g., a first external computer system different from the computer system), wherein: the content transmission information is associated with (e.g., corresponds to) a visual content item (e.g., 1046B, 1051A, or 1085A) received at and/or transmitted by the first external computer system (1104), and the content transmission information is sent to the computer system (e.g., 1000) (e.g., by an external computer system) in accordance with a determination that the visual content item received at and/or transmitted by the first external computer (e.g., 600) system satisfies a set of content criteria (1106) (e.g., a set of sensitive content criteria) (e.g., in accordance with a determination that the visual content item received at and/or transmitted by the first external computer system potentially contains sensitive content (e.g., inappropriate content, graphic content, and/or illegal content)) (e.g., based on one or more machine learning models).

The computer system detects (1108), via the one or more input devices, one or more user inputs (e.g., 1058, 1066, or 1074) (e.g., one or more tap inputs and/or one or more non-tap inputs) corresponding to a request to display a representation of the content transmission information (e.g., one or more user inputs corresponding to a request to display a user interface in which a representation of the content transmission information is displayed).

In response to detecting the one or more user inputs corresponding to the request to display the representation of the content transmission information (1110), the computer system displays (1112), via the display generation component and based on the received content transmission information, a user interface (e.g., 1070 or 1078) that includes a representation of at least some of the content transmission information (e.g., 1072A-1072D or 1080B-1080F) associated with the first external computer system (e.g., 600) (e.g., the visual content item, date and/or time the visual content item was received at and/or transmitted by the first external computer system, an indication that the first external computer system received sensitive content (e.g., the visual content item), an indication that the first external computer system transmitted sensitive content (e.g., the visual content item), contact information (e.g., name, phone number, and/or email address) for one or more users that received the sensitive content (e.g., the visual content item), and/or contact information (e.g., name, phone number, and/or email address) for one or more users that transmitted the sensitive content (e.g., the visual content item)). Displaying a user interface that includes a representation of content transmission information associated with a first external computer system, wherein the content transmission information is received in accordance with a determination that the first external computer system has received and/or transmitted a visual content item that satisfies a set of sensitive content criteria, provides security by providing notification of when unauthorized and/or sensitive content is received and/or transmitted by the first external computer system. Providing improved security enhances the operability of the device and makes the user-device interface more efficient and/or secure (e.g., by restricting unauthorized operations) which, additionally, reduces power usage and improves battery life of the device by limiting the performance of restricted operations.

In some embodiments, receiving the content transmission information associated with the first external computer system (e.g., 600) is performed in accordance with a determination that a content transmission setting (e.g., 1012A, 1028C, or 1056C) has been enabled (e.g., at the computer system and/or at the first external computer system). In some embodiments, if the content transmission setting is disabled (e.g., at the computer system and/or at the first external computer system), the computer system does not receive content transmission information corresponding to the first external computer system. Providing a setting that can be enabled so that the computer system can receive content transmission information if a first external computer system receives and/or transmits sensitive content provides security by allowing a user of the computer system to request notification of when unauthorized and/or sensitive content is received and/or transmitted by the first external computer system. Providing improved security enhances the operability of the device and makes the user-device interface more efficient and/or secure (e.g., by restricting unauthorized operations) which, additionally, reduces power usage and improves battery life of the device by limiting the performance of restricted operations.

In some embodiments, receiving the content transmission information associated with the first external computer system (e.g., 600) is performed in accordance with a determination that a content transmission setting (e.g., 1012A or 1028C) has been enabled at the first external computer system (e.g., 600). Providing a setting that can be enabled so that the computer system can receive content transmission information if a first external computer system receives and/or transmits sensitive content provides security by allowing a user of the computer system to request notification of when unauthorized and/or sensitive content is received and/or transmitted by the first external computer system. Having the setting be enabled and/or disabled t the first external computer system provides further security by ensuring that an unauthorized user is not able to receive notifications pertaining to the first external computer system (e.g., the setting must be enabled at the first external computer system). Providing improved security enhances the operability of the device and makes the user-device interface more efficient and/or secure (e.g., by restricting unauthorized operations) which, additionally, reduces power usage and improves battery life of the device by limiting the performance of restricted operations.

In some embodiments, in response to receiving the content transmission information associated with the first external computer system, the computer system displays, via the display generation component, a notification (e.g., 1090) corresponding to the content transmission information. In some embodiments, the notification indicates that the first external computer system has transmitted sensitive content has to another external computer system. In some embodiments, the notification indicates that the first external computer system has displayed sensitive content received from another external computer system. Displaying a notification corresponding to the content transmission information provides security by providing notification of when unauthorized and/or sensitive content is received and/or transmitted by the first external computer system. Providing improved security enhances the operability of the device and makes the user-device interface more efficient and/or secure (e.g., by restricting unauthorized operations) which, additionally, reduces power usage and improves battery life of the device by limiting the performance of restricted operations.

In some embodiments, the content transmission information is transmitted to the computer system (e.g., 1000) (e.g., by an external computer system) in accordance with a determination that visual content received at the first external computer system (e.g., 600) satisfies the set of content criteria (e.g., the set of sensitive content criteria), and that the first external computer system has received and has displayed visual content (e.g., FIG. 8I), and a second set of content transmission information is not transmitted to the computer system (e.g., 600) in accordance with a determination that a second set of visual content received at the first external computer system (e.g., 1000) was received by the first external computer system and was not displayed by the first external computer system (e.g., FIGS. 8E-8F). In some embodiments, content transmission information corresponding to a transmission instance at the first external computer system is only transmitted to the computer system if the first external computer system transmits sensitive content and/or displays sensitive content, and is not transmitted to the computer system if the first external computer system receives sensitive content, but opts not to view and/or display the sensitive content. Forgoing transmitting content transmission information if the first external computer receives, but does not view, sensitive visual content avoids unnecessary notifications, thereby conserving computing resources. Conserving computing resources enhances the operability of the device and makes the user-device interface more efficient (e.g., by avoiding unnecessary expenditure of computing resources) which, additionally, reduces power usage and improves battery life of the device by enabling the user to use the device more quickly and efficiently.

In some embodiments, the content transmission information includes information about the transmission and/or the receipt of the visual content item (e.g., 1080B-1080F) at the first external computer system (e.g., 600) (e.g., one or more recipients of the visual content item (e.g., contact name, phone number, email address, and/or user ID), one or more senders of the visual content item (e.g., contact name, phone number, email address, and/or user ID), device information for one or more recipients and/or senders of the visual content item (e.g., device name, device model, device manufacturer, and/or device ID), a time and/or date of transmission of the visual content item, and/or a time and/or date of receipt of the visual content item). Providing the computer system with content transmission information, including information about the transmission and/or the receipt of the visual content item at the first external computer system, provides security by providing information pertaining to unauthorized and/or sensitive content that is received and/or transmitted by the first external computer system. Providing improved security enhances the operability of the device and makes the user-device interface more efficient and/or secure (e.g., by restricting unauthorized operations) which, additionally, reduces power usage and improves battery life of the device by limiting the performance of restricted operations.

The content transmission information includes information about the visual content item (e.g., 1080B-1080F) (e.g., one or more categorizations of the visual content item (e.g., photo, video, text, potentially violent, potential drug use, and/or potential nudity)). In some embodiments, a copy of the visual content item is not included as part of the content transmission information (e.g., a copy of the visual content item is not transmitted to and/or received by the computer system). Providing the computer system with content transmission information, including information about the visual content item, provides security by providing information pertaining to unauthorized and/or sensitive content that is received and/or transmitted by the first external computer system. Providing improved security enhances the operability of the device and makes the user-device interface more efficient and/or secure (e.g., by restricting unauthorized operations) which, additionally, reduces power usage and improves battery life of the device by limiting the performance of restricted operations.

In some embodiments, at least a subset of the content transmission information (e.g., some or all of the content transmission information) is stored at the first external computer system (e.g., 600) (e.g., FIG. 10H, 1046B-1046G). In some embodiments, the at least the subset of the content transmission information can be displayed at the first external computer system (e.g., in response to one or more user inputs received at the first external computer system). Storing at least some of the content transmission information at the computer system and at the first external computer system enables the user to quickly access the content transmission information using either the computer system or the first external computer system, thereby reducing the number of inputs needed to access the content transmission information. Reducing the number of inputs needed to perform an operation enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, the first external computer system (e.g., 600) stores content transmission information corresponding to the visual content item (e.g., 1046B) that is not transmitted to and/or received by the computer system (e.g., FIG. 10M, 1078 does not include a copy of the content item) (e.g., a copy of the visual content item). In some embodiments, the additional content transmission information can be displayed at the first external computer system (e.g., in response to one or more user inputs received at the first external computer system). In some embodiments, the additional content transmission information cannot be displayed (e.g., is not accessible via) the computer system. Forgoing transmitting some of the content transmission information to the computer system provides security by limiting the amount of sensitive content that is transmitted between devices. Providing improved security enhances the operability of the device and makes the user-device interface more efficient and/or secure (e.g., by restricting unauthorized operations) which, additionally, reduces power usage and improves battery life of the device by limiting the performance of restricted operations.

In some embodiments, the visual content item is received and/or transmitted by the first external computer system (e.g., 600) within a communication session that includes the first external computer system (e.g., includes the first external computer system and one or more additional external computer systems); and the content transmission information includes one or more messages (e.g., 1085B) that were transmitted into the communication session (e.g., by the first external computer system and/or one or more other external computer systems that are part of the communication session) before and/or after the visual content item (e.g., immediately before and/or immediately after the visual content item was transmitted into the communication session). Including one or more messages that were transmitted into the communication session before and/or after the visual content item with the content transmission information enables a user to quickly access the context around the transmission of visual content item, thereby reducing the number of inputs needed to access such information. Reducing the number of inputs needed to perform an operation enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, the content transmission information is persistently stored at the computer system (e.g., the content transmission information remains stored on the computer system even after the computer system is powered down and powered back on), and is accessible on the computer system via a settings user interface (e.g., 1054, 1068, or 1078). In some embodiments, the settings user interface provides access to content transmission information for a plurality of visual content items that were received at and/or transmitted by the first external computer system (e.g., a plurality of visual content items that were received at and/or transmitted by the first external computer system and satisfy the set of sensitive content criteria) (e.g., provides access to content transmission information for a plurality of transmission instances taking place at different times). Persistently storing the content transmission information enables a user to access the content transmission information in the future, as needed. Providing users with access to information enhances the operability of the device and makes the user-device interface more efficient (e.g., by helping the user to access the desired information) which, additionally, reduces power usage and improves battery life of the device by enabling the user to use the device more quickly and efficiently.

In some embodiments, in response to detecting the one or more user inputs corresponding to the request to display the representation of the content transmission information, the computer system displays (e.g., concurrently with the user interface), via the display generation component, a selectable object that is selectable to initiate a process for reporting (e.g., to a third party) a sender of the visual content item (e.g., 1080H). In some embodiments, while displaying the selectable object, the computer system detects, via the one or more input devices, one or more user inputs corresponding to a request to report the sender of the visual content item, including one or more user inputs corresponding to selection of the selectable object; and in response to detecting the one or more user inputs corresponding to the request to report the sender of the visual content item, the computer system transmits sender information corresponding to the sender of the visual content item to a third party (and, optionally, transmits visual content item information corresponding to the visual content item to the third party). Displaying the selectable object that is selectable to initiate a process for reporting the sender of the visual content enables a user to quickly report the sender of the visual content, thereby reducing the number of inputs needed to report the sender of the visual content. Reducing the number of inputs needed to perform an operation enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, prior to displaying the user interface (e.g., 1078) that includes the representation of at least some of the content transmission information (e.g., 1080B-1080F) associated with the first external computer system (e.g., 600) (e.g., in response to detecting the one or more user inputs corresponding to the request to display the representation of the content transmission information), the computer system displays, via the display generation component, an authentication user interface (e.g., 1060) that prompts a user for authentication information (e.g., a password entry user interface requesting entry of a user password and/or a PIN entry user interface requesting entry of a user PIN). In some embodiments, while displaying the authentication user interface, the computer system receives, via the one or more input devices, authentication information; in response to receiving the authentication information: in accordance with a determination that the authentication information satisfies a set of authentication criteria (e.g., an entered PIN matches a stored PIN and/or an entered password matches a stored password), the computer system displays the user interface that includes the representation of at least some of the content transmission information associated with the first external computer system. Displaying an authentication user interface requesting authentication information prior to displaying the user interface that includes the representation of at least some of the content transmission information provides security and can prevent unauthorized users from initiating sensitive operations and/or accessing sensitive information. Providing improved security enhances the operability of the device and makes the user-device interface more efficient and/or secure (e.g., by restricting unauthorized access) which, additionally, reduces power usage and improves battery life of the device by limiting the performance of restricted operations.

In some embodiments, the content transmission information includes an indication (e.g., 1080D) that the visual content item has been deleted from the first external computer system. In some embodiments, displaying the user interface that includes the representation of at least some of the content transmission information associated with the first external computer system includes displaying an indication that the visual content item has been deleted from the first external computer system. Including, with the content transmission information, an indication that the visual content item has been deleted from the first external computer system provides security by allowing a user of the computer system to know that sensitive content has been received and/or transmitted by the first external computer system even if it is deleted from the first external computer system. Providing improved security enhances the operability of the device and makes the user-device interface more efficient and/or secure (e.g., by restricting unauthorized access) which, additionally, reduces power usage and improves battery life of the device by limiting the performance of restricted operations.

Note that details of the processes described above with respect to method 1100 (e.g., FIG. 11) are also applicable in an analogous manner to the methods described above. For example, methods 700 and 900 optionally include one or more of the characteristics of the various methods described above with reference to method 1100. For example, sensitive content transmitted by a computer system in method 700 and/or received by a computer system in method 900 can be reported to the computer system in method 1100. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve identification of sensitive content. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to accurately identify sensitive content. Accordingly, use of such personal information data enables users to have calculated control of receipt and transmission of sensitive content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of content transmission services, the present technology can be configured to allow users to select to “opt in” or “opt out” of participation in the collection of personal information data during registration for services or anytime thereafter. In another example, users can select not to enable sensitive content identification. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, identification of sensitive content can be performed based on non-personal information data or a bare minimum amount of personal information, such as the content being requested by the device associated with a user, other non-personal information available to the content transmission services, or publicly available information.

What is claimed is:

1. A computer system configured to communicate with a display generation component and one or more input devices, comprising:
one or more processors; and
memory storing one or more programs configured to be executed by the one or more processors, the one or more programs including instructions for:
displaying, via the display generation component, a communication session user interface corresponding to a communication session involving the computer system and one or more external computer systems, including a first external computer system;
receiving visual content information corresponding to visual content transmitted into the communication session by the first external computer system; and
in response to receiving the visual content information corresponding to visual content transmitted into the communication session by the first external computer system:
in accordance with a determination that the visual content satisfies a set of sensitive content criteria, displaying, via the display generation component, a visual indication that the received visual content has been identified as potentially containing sensitive content without displaying the visual content.

2. The computer system of claim 1, wherein the visual indication that the received visual content has been identified as potentially containing sensitive content includes a textual indication that the visual content has been identified as potentially containing sensitive content.

3. The computer system of claim 1, wherein displaying the visual indication that the received visual content has been identified as potentially containing sensitive content without displaying the visual content includes displaying a representation of the visual content without displaying the visual content.

4. The computer system of claim 1, the one or more programs further including instructions for:
in accordance with the determination that the visual content satisfies the set of sensitive content criteria:
displaying, via the display generation component, a first selectable object that is selectable to initiate a process for displaying the visual content.

5. The computer system of claim 4, the one or more programs further including instructions for:
subsequent to displaying the first selectable object, detecting, via the one or more input devices, one or more user inputs corresponding to a user request to display the visual content, wherein the one or more user inputs corresponding to the user request to display the visual content includes one or more user inputs corresponding to selection of the first selectable object; and
in response to detecting the one or more user inputs corresponding to the user request to display the visual content, displaying, via the display generation component, the visual content.

6. The computer system of claim 5, the one or more programs further including instructions for:
in response to detecting the one or more user inputs corresponding to the user request to display the visual content, displaying a first option that is selectable to initiate a process to indicate that the visual content does not depict sensitive content.

7. The computer system of claim 6, the one or more programs further including instructions for:
while displaying the first option, detecting, via the one or more input devices, one or more user inputs corresponding to selection of the first option; and
subsequent to detecting the one or more user inputs corresponding to selection of the first option, displaying, via the display generation component, an authentication user interface that prompts a user for authentication information.

8. The computer system of claim 5, wherein the one or more user inputs corresponding to the user request to display the visual content cause a second external computer system to receive a notification indicating that the computer system has received and displayed visual content potentially containing sensitive content.

9. The computer system of claim 5, wherein the one or more user inputs corresponding to the user request to display the visual content cause a third external computer system to receive information pertaining to the received visual content.

10. The computer system of claim 4, the one or more programs further including instructions for:
in accordance with the determination that the visual content satisfies the set of sensitive content criteria:
displaying, via the display generation component, a second selectable object that is selectable to forgo displaying the visual content.

11. The computer system of claim 10, wherein:
displaying the visual indication that the received visual content has been identified as potentially containing sensitive content without displaying the visual content includes displaying a representation of the visual content; and
the one or more programs further include instructions for:
while displaying the second selectable object, detecting, via the one or more input devices, one or more user inputs corresponding to selection of the second selectable object; and
in response to detecting the one or more user inputs corresponding to selection of the second selectable object, ceasing to display the representation of the visual content.

12. The computer system of claim 1, wherein:
the visual content includes a first media item and a second media item different from the first media item, and
the one or more programs further include instructions for:
in response to receiving the visual content information corresponding to visual content transmitted into the communication session by the first external computer system:
in accordance with a determination that the first media item satisfies the set of sensitive content criteria, and that the second media item does not satisfy the set of sensitive content criteria:
displaying, via the display generation component, the second media item; and
displaying, via the display generation component, a visual indication that the first media item has been identified as potentially containing sensitive content without displaying the first media item.

13. The computer system of claim 1, wherein:
the visual content includes a plurality of media items including a first media item and a second media item different from the first media item, and
the one or more programs further include instructions for:
in response to receiving the visual content information corresponding to visual content transmitted into the communication session by the first external computer system:
in accordance with a determination that the first media item satisfies the set of sensitive content criteria, and that the second media item does not satisfy the set of sensitive content criteria:
displaying, via the display generation component, a visual indication that one or more media items of the visual content has been identified as potentially containing sensitive content without displaying the first media item and without displaying the second media item.

14. The computer system of claim 1, the one or more programs further including instructions for:
subsequent to receiving the visual content information corresponding to visual content transmitted into the communication session by the first external computer system, and in accordance with the determination that the visual content satisfies the set of sensitive content criteria:
displaying, via the display generation component, a third selectable object that is selectable to initiate a process for reporting a sender of the visual content.

15. The computer system of claim 1, the one or more programs further including instructions for:
subsequent to receiving the visual content information corresponding to visual content transmitted into the communication session by the first external computer system, and in accordance with the determination that the visual content satisfies the set of sensitive content criteria:
displaying, via the display generation component, a fourth selectable object that is selectable to initiate a process for leaving the communication session.

16. The computer system of claim 1, the one or more programs further including instructions for:
subsequent to receiving the visual content information corresponding to visual content transmitted into the communication session by the first external computer system, and in accordance with the determination that the visual content satisfies the set of sensitive content criteria:
displaying, via the display generation component, a fifth selectable object that is selectable to initiate a process for blocking a sender of the visual content.

17. The computer system of claim 1, wherein the visual content cannot be saved to the computer system and/or shared by the computer system until the visual content is displayed on the computer system.

18. The computer system of claim 1, the one or more programs further including instructions for:
in accordance with the determination that the visual content satisfies the set of sensitive content criteria:
displaying, via the display generation component, a sixth selectable object that is selectable to initiate a process for transmitting a message into a second communication session different from the communication session, wherein the second communication session involves the computer system and a fourth external computer system different from the first external computer system.

19. The computer system of claim 18, the one or more programs further including instructions for:
subsequent to displaying the sixth selectable object, detecting, via the one or more input devices, one or more user inputs corresponding to selection of the sixth selectable object; and
in response to detecting the one or more user inputs corresponding to selection of the sixth selectable object, displaying, via the display generation component, a communication session user interface corresponding to the second communication session, including displaying, within the communication session user interface corresponding to the second communication session, a prepopulated message that notifies a user of the fourth external computer system of the visual content transmitted into the communication session by the first external computer system.

20. A non-transitory computer-readable storage medium storing one or more programs configured to be executed by one or more processors of a computer system that is in communication with a display generation component and one or more input devices, the one or more programs including instructions for:
displaying, via the display generation component, a communication session user interface corresponding to a communication session involving the computer system and one or more external computer systems, including a first external computer system;
receiving visual content information corresponding to visual content transmitted into the communication session by the first external computer system; and
in response to receiving the visual content information corresponding to visual content transmitted into the communication session by the first external computer system:
in accordance with a determination that the visual content satisfies a set of sensitive content criteria, displaying, via the display generation component, a visual indication that the received visual content has been identified as potentially containing sensitive content without displaying the visual content.

21. A method, comprising:
at a computer system that is in communication with a display generation component and one or more input devices:
displaying, via the display generation component, a communication session user interface corresponding to a communication session involving the computer system and one or more external computer systems, including a first external computer system;
receiving visual content information corresponding to visual content transmitted into the communication session by the first external computer system; and
in response to receiving the visual content information corresponding to visual content transmitted into the communication session by the first external computer system:
in accordance with a determination that the visual content satisfies a set of sensitive content criteria, displaying, via the display generation component, a visual indication that the received visual content has been identified as potentially containing sensitive content without displaying the visual content.
